(19) United States
(12) Patent Application Publication
(10) Pub. No.: US 2025/0016758 A1
(43) Pub. Date: Jan. 9, 2025

(54) BEAM CHANGE REPORTING VIA PREDICTION BASED BEAM MANAGEMENT

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Tao Luo, San Diego, CA (US)

(21) Appl. No.: 18/707,045

(22) PCT Filed: Dec. 14, 2021
(86) PCT No.: PCT/CN2021/137740

§ 371 Date: May 2, 2024

(51) Int. Cl. H04W 72/044; H04W 24/10

(52) U.S. Cl. CPC H04W 72/046; H04W 24/10

(57) ABSTRACT

Methods, systems, and devices for wireless communications are described. A UE may receive, from a base station, a configuration for a channel state report setting. The UE may transmit, to the base station, a request for additional reporting quantities for the channel state report setting or to change one or more parameters of the channel state report setting based at least in part on the configuration. For example, the UE may transmit a request to change the periodicity of the channel state report, to transmit an additional, unscheduled channel state report, to increase or decrease the channel state information reference signal resources or the synchronization signal block resources associated with the channel state report setting, or to report a beam change incident. The UE may transmit a channel state report based on the configuration and the request to change the channel state report setting or the one or more parameters.

### CROSS REFERENCE

The present Application is a 371 national stage filing of International PCT Application No. PCT/CN2021/137740 by Li et al. entitled “BEAM CHANGE REPORTING VIA PREDICTION BASED BEAM MANAGEMENT,” filed Dec. 14, 2021, which is assigned to the assignee hereof, and which is expressly incorporated by reference in its entirety herein.

### FIELD OF TECHNOLOGY

The present disclosure relates to wireless communications, including beam change reporting via prediction based beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support beam change reporting via prediction based beam management. Generally, the described techniques provide for flexible beam reporting and management. In some cases, a user equipment (UE) may transmit a request to modify channel state report settings including settings for beam reporting. A UE may receive, from the base station, a configuration for a channel state report setting. The UE may transmit, to the base station, a request for additional reporting quantities for the channel state report setting or to change one or more parameters of the channel state report setting based at least in part on the configuration. For example, the UE may transmit a request to change the periodicity of the channel state report, to transmit an additional, unscheduled channel state report, to increase or decrease the channel state information reference signal resources or the synchronization signal block resources associated with the channel state report setting, or to report a beam change incident. The UE may transmit a channel state report based on the configuration and the request to change the channel state report setting or the one or more parameters.

A method for wireless communications at a UE is described. The method may include receiving, from a base station, a configuration for a channel state report setting, where the configuration for the channel state report setting is associated with a number of bits, transmitting, to the base station, a request for an additional reporting quantity for the channel state report setting or to change one or more parameters of the channel state report setting, and transmitting, to the base station, a channel state report using the number of bits based on the configuration and the request.

An apparatus for wireless communications at a UE is described. The apparatus may include a processor, memory coupled with the processor, and instructions stored in the memory. The instructions may be executable by the processor to cause the apparatus to receive, from a base station, a configuration for a channel state report setting, where the configuration for the channel state report setting is associated with a number of bits, transmit, to the base station, a request for an additional reporting quantity for the channel state report setting or to change one or more parameters of the channel state report setting, and transmit, to the base station, a channel state report using the number of bits based on the configuration and the request.

Another apparatus for wireless communications at a UE is described. The apparatus may include means for receiving, from a base station, a configuration for a channel state report setting, where the configuration for the channel state report setting is associated with a number of bits, means for transmitting, to the base station, a request for an additional reporting quantity for the channel state report setting or to change one or more parameters of the channel state report setting, and means for transmitting, to the base station, a channel state report using the number of bits based on the configuration and the request.

A non-transitory computer-readable medium storing code for wireless communications at a UE is described. The code may include instructions executable by a processor to receive, from a base station, a configuration for a channel state report setting, where the configuration for the channel state report setting is associated with a number of bits, transmit, to the base station, a request for an additional reporting quantity for the channel state report setting or to change one or more parameters of the channel state report setting, and transmit, to the base station, a channel state report using the number of bits based on the configuration and the request.

In some examples of the method, apparatuses, and non-transitory computer-readable medium described herein, transmitting the channel state report may include operations, features, means, or instructions for transmitting, with the channel state report, a code point of a set of code points of a beam report, the code point indicating use of the additional reporting quantity for the channel state report setting or one or more changed parameters of the channel state report setting.

In some examples of the method, apparatuses, and non-transitory computer-readable medium described herein, transmitting the code point may include operations, features, means, or instructions for transmitting the code point that may be selected from the second subset of the set of code points.

Some examples of the method, apparatuses, and non-transitory computer-readable medium described herein may further include operations, features, means, or instructions for receiving, from the base station, a message indicating a request configuration, where the request configuration includes an indication of the code point for indicating use of the additional reporting quantity for the channel state report setting or the one or more changed parameters of the channel state report setting.

In some examples of the method, apparatuses, and non-transitory computer-readable medium described herein, transmitting the request may include operations, features, means, or instructions for transmitting an indication of the additional reporting quantity for the channel state report setting or the one or more changed parameters of the channel state report setting using either a first set of bits for reporting the set of code points or a second set of bits of a payload of the channel state report, where the second set of bits may be different from the first set of bits.

In some examples of the method, apparatuses, and non-transitory computer-readable medium described herein, different respective code points in the set of code points of the beam report indicate use of different respective reporting quantities for the channel state report or different respective parameters for the channel state report.

In some examples of the method, apparatuses, and non-transitory computer-readable medium described herein, transmitting the request to the base station may include operations, features, means, or instructions for transmitting the request indicating to the base station to interpret a second report for reporting a second strongest beam in terms of either the layer one reference signal received power or the layer one signal to interference and noise ratio as reporting the strongest beam in terms of either the layer one reference signal received power or the layer one signal to interference and noise ratio.

In some examples of the method, apparatuses, and non-transitory computer-readable medium described herein, transmitting the channel state report may include operations, features, means, or instructions for transmitting the second report indicating at least one of an absolute reference signal received power or an absolute signal to interference and noise ratio of the strongest beam, where a first step size associated with reporting the absolute reference signal received power or the absolute signal to interference and noise ratio of the strongest beam in the second report may be different than a second step size associated with reporting a differential reference signal received power or a differential signal to interference and noise ratio of the strongest beam in the first report.

Some examples of the method, apparatuses, and non-transitory computer-readable medium described herein may further include operations, features, means, or instructions for transmitting, with the channel state report, the second report, where the second report indicates, based on the request, to interpret a previous strongest beam indicated by a previous first beam report in a previous channel state report as the strongest beam.

Some examples of the method, apparatuses, and non-transitory computer-readable medium described herein may further include operations, features, means, or instructions for transmitting, with the channel state report, the second report, where the second report indicates, based on the request, to interpret the first report as reporting the strongest beam according to an updated reporting configuration.

In some examples of the method, apparatuses, and non-transitory computer-readable medium described herein, transmitting the channel state report based on the configuration and the request may include operations, features, means, or instructions for transmitting a second set of beam reports using a second number of bits based on the request, where the second number of bits may be less than a first number of bits configured for transmitting a first set of beam reports according to the configuration, where the second set of beam reports includes the beam report.

In some examples of the method, apparatuses, and non-transitory computer-readable medium described herein, the second set of beam reports includes less beam reports than the first set of beam reports.

In some examples of the method, apparatuses, and non-transitory computer-readable medium described herein, each of the first set of beam reports and the second set of beam reports may be associated with a respective range and a second range of at least one beam report of the second set of beam reports may be less than a first range of a corresponding beam report of the first set of beam reports.

In some examples of the method, apparatuses, and non-transitory computer-readable medium described herein, each of the first set of beam reports and the second set of beam reports may be associated with a respective step size and a second step size of at least one beam report of the second set of beam reports may be less than a first step size of a corresponding beam report of the first set of beam reports.

In some examples of the method, apparatuses, and non-transitory computer-readable medium described herein, transmitting the request may include operations, features, means, or instructions for transmitting, with the channel state report, a bit in addition to a payload of the channel state report, the bit indicating the request.

In some examples of the method, apparatuses, and non-transitory computer-readable medium described herein, transmitting the channel state report may include operations, features, means, or instructions for indicating, via one or more bits associated with the payload of the channel state report, the additional reporting quantity for the channel state report or the one or more parameters of the channel state report.

In some examples of the method, apparatuses, and non-transitory computer-readable medium described herein, transmitting the channel state report may include operations, features, means, or instructions for indicating, via one or more bits in addition to the payload of the channel state report, the additional reporting quantity for the channel state report or the one or more parameters of the channel state report.

In some examples of the method, apparatuses, and non-transitory computer-readable medium described herein, transmitting the channel state report based on the configuration and the request may include operations, features, means, or instructions for transmitting a second set of beam reports using a second number of bits based on the request, where the second number of bits may be less than a first number of bits configured for transmitting a first set of beam reports according to the configuration.

In some examples of the method, apparatuses, and non-transitory computer-readable medium described herein, transmitting the request may include operations, features, means, or instructions for transmitting an indication to change a periodicity associated with future channel state reports.

In some examples of the method, apparatuses, and non-transitory computer-readable medium described herein, transmitting the request may include operations, features, means, or instructions for transmitting a message requesting a second channel state report in addition to the set of scheduled channel state reports.

Some examples of the method, apparatuses, and non-transitory computer-readable medium described herein may further include operations, features, means, or instructions for transmitting the request includes transmitting a message requesting to change the one or more parameters and the one or more parameters include a number of channel state information reference signal resources associated with the channel state report setting or a number of synchronization signal block resources associated with the channel state report setting.

In some examples of the method, apparatuses, and non-transitory computer-readable medium described herein, transmitting the request may include operations, features, means, or instructions for transmitting a message reporting a predicted beam change incident.

In some examples of the method, apparatuses, and non-transitory computer-readable medium described herein, the additional reporting quantity includes a synchronization signal block index reference signal received power, a synchronization signal block index signal to interference and noise ratio, a channel state information resource indicator reference signal received power, or a channel state information resource indicator signal to interference and noise ratio.

A method for wireless communications at a base station is described. The method may include transmitting, to a UE, a configuration for a channel state report setting, where the configuration for the channel state report setting is associated with a number of bits, receiving, from the UE, a request for an additional reporting quantity for the channel state report setting or to change one or more parameters of the channel state report setting, and receiving, from the UE, a channel state report using the number of bits based on the configuration and the request.

An apparatus for wireless communications at a base station is described. The apparatus may include a processor, memory coupled with the processor, and instructions stored in the memory. The instructions may be executable by the processor to cause the apparatus to transmit, to a UE, a configuration for a channel state report setting, where the configuration for the channel state report setting is associated with a number of bits, receive, from the UE, a request for an additional reporting quantity for the channel state report setting or to change one or more parameters of the channel state report setting, and receive, from the UE, a channel state report using the number of bits based on the configuration and the request.

Another apparatus for wireless communications at a base station is described. The apparatus may include means for transmitting, to a UE, a configuration for a channel state report setting, where the configuration for the channel state report setting is associated with a number of bits, means for receiving, from the UE, a request for an additional reporting quantity for the channel state report setting or to change one or more parameters of the channel state report setting, and means for receiving, from the UE, a channel state report using the number of bits based on the configuration and the request.

A non-transitory computer-readable medium storing code for wireless communications at a base station is described. The code may include instructions executable by a processor to transmit, to a UE, a configuration for a channel state report setting, where the configuration for the channel state report setting is associated with a number of bits, receive, from the UE, a request for an additional reporting quantity for the channel state report setting or to change one or more parameters of the channel state report setting, and receive, from the UE, a channel state report using the number of bits based on the configuration and the request.

In some examples of the method, apparatuses, and non-transitory computer-readable medium described herein, receiving the request may include operations, features, means, or instructions for receiving, with the channel state report, a code point of a set of code points of a beam report, indicating use of the additional reporting quantity for the channel state report setting or one or more changed parameters of the channel state report setting.

In some examples of the method, apparatuses, and non-transitory computer-readable medium described herein, receiving the code point may include operations, features, means, or instructions for receiving the code point that may be selected from the second subset of the set of code points.

Some examples of the method, apparatuses, and non-transitory computer-readable medium described herein may further include operations, features, means, or instructions for transmitting, to the UE, a message indicating a request configuration, where the request configuration includes an indication of the code point for indicating use of the additional reporting quantity for the channel state report setting or the one or more changed parameters of the channel state report setting.

In some examples of the method, apparatuses, and non-transitory computer-readable medium described herein, receiving the request may include operations, features, means, or instructions for receiving an indication of the additional reporting quantity for the channel state report setting or the one or more changed parameters of the channel state report setting using either a first set of bits for reporting the set of code points or a second set of bits of a payload of the channel state report, where the second set of bits may be different from the first set of bits.

### BRIEF DESCRIPTION OF THE DRAWINGS

FIG. 1 illustrates an example of a wireless communications system that supports beam change reporting via prediction based beam management in accordance with aspects of the present disclosure.

FIG. 2a illustrates an example of a wireless communications system that supports beam change reporting via prediction based beam management in accordance with aspects of the present disclosure.

FIG. 2b illustrates an example of a wireless communications system that supports beam change reporting via prediction based beam management in accordance with aspects of the present disclosure.

FIG. 3 illustrates an example of a timing diagram that supports beam change reporting via prediction based beam management in accordance with aspects of the present disclosure.

FIG. 4 illustrates an example of a wireless communications system that supports beam change reporting via prediction based beam management in accordance with aspects of the present disclosure.

FIG. 5 illustrates an example of a process flow that supports beam change reporting via prediction based beam management in accordance with aspects of the present disclosure.

FIGS. 6 and 7 show block diagrams of devices that support beam change reporting via prediction based beam management in accordance with aspects of the present disclosure.

FIG. 8 shows a block diagram of a communications manager that supports beam change reporting via prediction based beam management in accordance with aspects of the present disclosure.

FIG. 9 shows a diagram of a system including a device that supports beam change reporting via prediction based beam management in accordance with aspects of the present disclosure.

FIGS. 10 and 11 show block diagrams of devices that support beam change reporting via prediction based beam management in accordance with aspects of the present disclosure.

FIG. 12 shows a block diagram of a communications manager that supports beam change reporting via prediction based beam management in accordance with aspects of the present disclosure.

FIG. 13 shows a diagram of a system including a device that supports beam change reporting via prediction based beam management in accordance with aspects of the present disclosure.

FIGS. 14 through 18 show flowcharts illustrating methods that support beam change reporting via prediction based beam management in accordance with aspects of the present disclosure.

### DETAILED DESCRIPTION

In some wireless communications systems, a user equipment (UE) may report, to a base station, various parameters associated with one or more beams for communications between the UE and the base station in a channel state report. The parameters reported may be configured by the base station. The parameters may include a number of bits used to report a reference signal received power (RSRP) of the beam(s), a number of bits used to report the signal to interference and noise ratio (SINR) of the beam(s), or a step size used or range used to report the RSRP and or SINR (e.g., in decibels). Frequent beam reporting (e.g., every 20 or 40 milliseconds (ms)) may consume UE-specific overhead and power. If a UE is stationary or moving at a low rate, the strongest beams may not change often (e.g., may not change over hundreds of ms). Some UEs may be configured to predict a future strongest beam and/or a time when the strongest beam will change. Current beam reporting configurations may not allow UEs to change a periodicity of the beam reporting, and thus UEs may expend excessive overhead and power on beam reporting under some conditions.

In some cases, a UE may transmit a request to modify channel state report settings including settings for beam reporting. A UE may receive, from the base station a configuration for a channel state report setting. The UE may transmit, to the base station, a request for additional reporting quantities for the channel state report setting or to change one or more parameters of the channel state report setting based at least in part on the configuration. For example, the UE may transmit a request to change the periodicity of the channel state report, to transmit an additional, unscheduled channel state report, to increase or decrease the channel state information (CSI) reference signal (CSI-RS) resources or the synchronization signal block (SSB) resources associated with the channel state report setting, or to report a beam change incident. The UE may transmit a channel state report based on the configuration and the request to change the channel state report setting or the one or more parameters. Accordingly, the UE may more flexibly perform beam reporting.

In some examples, the request to modify channel state report settings may indicate to the base station to reinterpret a payload of the channel state report. For example, the UE may indicate the request using one or more bits of a channel state report. For example, the UE may indicate an invalid RSRP of a beam in the channel state report which may indicate to the base station to reinterpret the channel state report according to updated settings of the channel state report. In some cases, the one or more bits used to indicate the request may be configured by the base station, and the same one or more bits or a different set of bits of the channel state report may indicate particular parameters of the channel state report setting or the reporting quantities to change.

Aspects of the disclosure are initially described in the context of wireless communications systems. Aspects of the disclosure are further illustrated by and described with reference to wireless communications systems, timing diagrams, and process flows. Aspects of the disclosure are further illustrated by and described with reference to apparatus diagrams, system diagrams, and flowcharts that relate to beam change reporting via prediction based beam management.

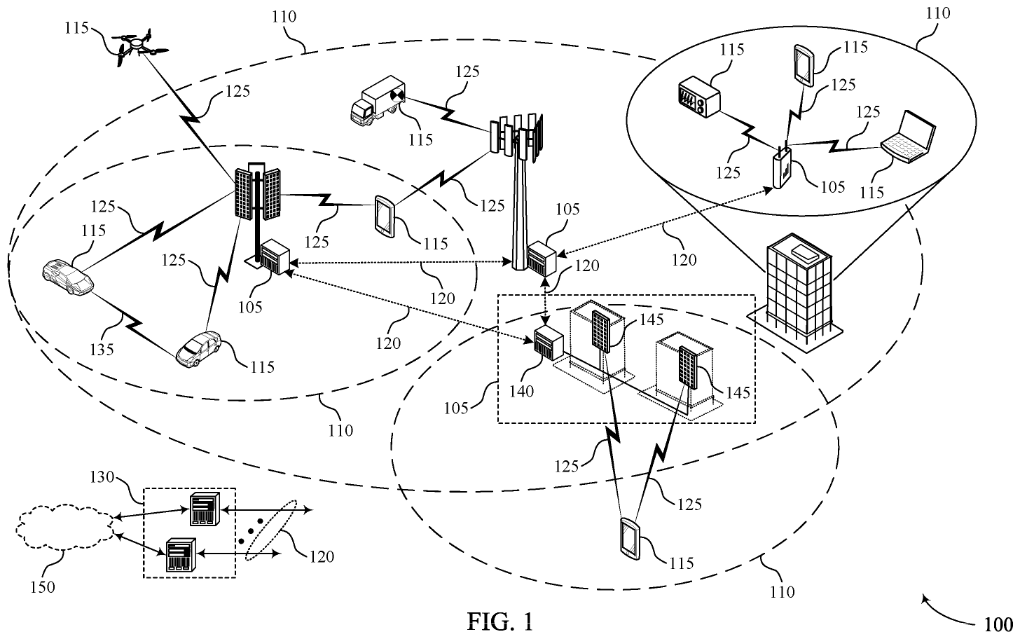

FIG. 1 illustrates an example of a wireless communications system 100 that supports beam change reporting via prediction based beam management in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may report, to a base station 105, various parameters associated with one or more beams for communications between the UE 115 and the base station 105 in a channel state report. The parameters reported may be configured by the base station 105. The parameters may include a number of bits used to report an RSRP of the beam(s), a number of bits used to report SINR of the beam(s), a step size used or range used to report the RSRP and or SINR (e.g., in decibels). Frequent beam reporting (e.g., every 20 or 40 ms) may consume UE 115-specific overhead and power. If a UE 115 is stationary or moving at a low rate, the strongest beams may not change often (e.g., may not change over hundreds of ms). Some UEs 115 may be configured to predict a future strongest beam and/or a time when the strongest beam will change. Current beam reporting configurations may not allow a UE 115 to change a periodicity of the beam reporting, and thus UEs 115 may expend excessive overhead and power on beam reporting under some conditions.

In some cases, a UE 115 may transmit a request to modify channel state report settings including settings for beam reporting. A UE 115 may receive, from the base station 105, a configuration for a channel state report setting. The UE 115 may transmit, to the base station 105, a request for additional reporting quantities for the channel state report setting or to change one or more parameters of the channel state report setting based at least in part on the configuration. For example, the UE 115 may transmit a request: to change the periodicity of the channel state report; to transmit an additional, unscheduled channel state report; to increase or decrease the CSI-RS resources or the SSB resources associated with the channel state report setting; or to report a beam change incident. The UE 115 may transmit a channel state report based on the configuration and the request to change the channel state report setting or the one or more parameters. Accordingly, the UE 115 may more flexibly perform beam reporting.

In some examples, the request to modify channel state report settings may indicate to the base station 105 to reinterpret a payload of the channel state report. For example, the UE 115 may indicate the request using one or more bits of a channel state report. For example, the UE 115 may indicate an invalid RSRP of a beam in the channel state report which may indicate to the base station 105 to reinterpret the channel state report according to updated settings of the channel state report. In some cases, the one or more bits used to indicate the request may be configured by the base station 105, and the same one or more bits or a different set of bits of the channel state report may indicate particular parameters of the channel state report setting or the reporting quantities to change.

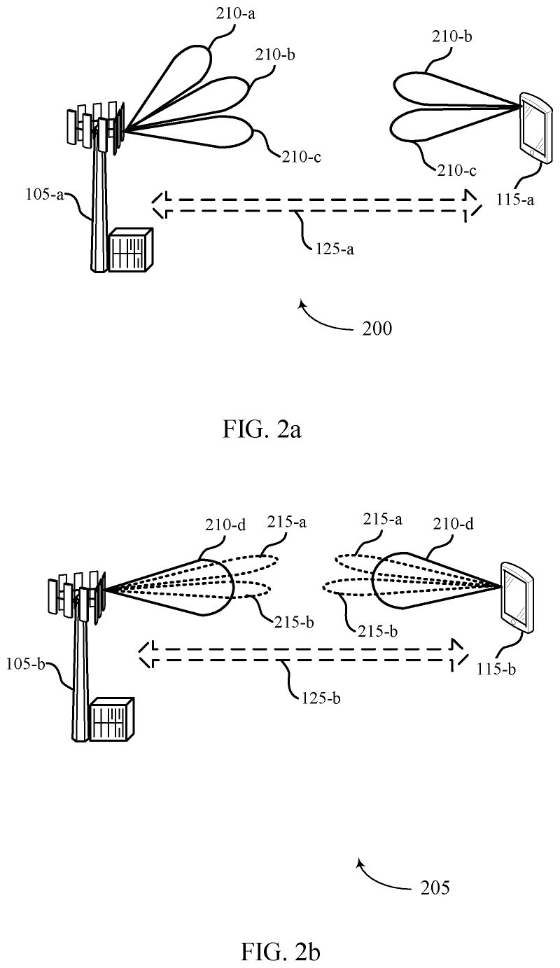

FIG. 2a illustrates an example of a wireless communications system 200 that supports beam change reporting via prediction based beam management in accordance with aspects of the present disclosure. In some examples, the wireless communications system 200 may be implemented by or may implement aspects of the wireless communications system 100 as described with reference to FIG. 1. The wireless communications system 200 may include a UE 115-a which may be an example of a UE 115 as described herein. The wireless communications system 200 may also include a base station 105-a which may be an example of a base station 105 as described herein. In some examples, the base station 105-a may communicate with the UE 115-a using directional communications techniques. For example, the base station 105-a may communicate with the UE 115-a via one or more beams 210. The base station 105-a may communicate with the UE 115-a via a communication link 125-a, which may be an example of an NR or LTE link between the UE 115-a and the base station 105-a. In some cases, the communication link 125-a may include an example of an access link (e.g., Uu link). The communication link 125-a may include a bi-directional link that enables both uplink and downlink communication. For example, the UE 115-a may transmit uplink signals, such as uplink control signals or uplink data signals, to the base station 105-a using the first communication link 125-a and the base station 105-a may transmit downlink signals, such as downlink control signals or downlink data signals, to the first UE 115-a using the communication link 125-a.

As part of transmitting downlink data to the UE 115-a via the communication link 125-a, the base station 105-a may cover the UE 115-a with one or more transmission beams. More specifically, the base station 105-a may sweep a set of transmission beams (e.g., a first transmission beam 210-a, a second transmission beam 210-b, and a third transmission beam 210-c) across the communication link 125-a according to a beam sweep pattern. In some examples, the beam sweeping pattern may include transmitting a set of SSBs across the set of transmission beams 210. The base station 105-a may transmit or otherwise provide an indication of the beam sweep pattern to the UE 115-a. The UE 115-a may perform measurements upon the SSBs received across the beams 210 and transmit a report to the base station 105-a indicating information based on the measurements. For example, the report may indicate a strongest beam. The UE 115-a and the base station 105-a may establish communications over the communication link 125-a based on the report. For example, the base station 105-a and the UE 115-a may perform an SSB beam sweep and report procedure during an initial access procedure (e.g., as part of a random access channel (RACH) procedure). Beams used for SSB beam sweeping may be wide beams (e.g., layer 1 (L1) beams).

FIG. 2b illustrates an example of a wireless communications system 205 that supports beam change reporting via prediction based beam management in accordance with aspects of the present disclosure. In some examples, the wireless communications system 205 may be implemented by or may implement aspects of the wireless communications system 100 or the wireless communications system 200 as described with reference to FIGS. 1 and 2a. The wireless communications system 205 may include a UE 115-b which may be an example of a UE 115 as described herein. The wireless communications system 205 may also include a base station 105-b which may be an example of a base station 105 as described herein.

In some examples, the base station 105-b may communicate with the UE 115-b using directional communications techniques. For example, the base station 105-b may communicate with the UE 115-b via one or more beams 210. The base station 105-b may communicate with the UE 115-b via a communication link 125-b, which may be an example of an NR or LTE link between the UE 115-b and the base station 105-b. In some cases, the communication link 125-b may include an example of an access link (e.g., Uu link). The communication link 125-b may include a bi-directional link that enables both uplink and downlink communication. For example, the UE 115-b may transmit uplink signals, such as uplink control signals or uplink data signals, to the base station 105-b using the first communication link 125-b and the base station 105-b may transmit downlink signals, such as downlink control signals or downlink data signals, to the first UE 115-a using the communication link 125-b.

As part of transmitting downlink data to the UE 115-b via the respective communication link 125-b, the base station 105-b may cover the UE 115-b with one or more transmission beams. More specifically, the base station 105-b may sweep a set of transmission beams 210-d across the communication link 125-b according to a beam sweep pattern. In some examples, the beam sweeping pattern may include transmitting a set of CSI-RSs across the set of transmission beams 210-d (e.g., the base station 105-b may transmit CSI-RS 215-a and CSI-RS 215-b). The base station 105-b may transmit or otherwise provide an indication of the beam sweep pattern to the UE 115-b. The UE 115-b may perform CSI measurements upon the CSI-RSs received across the beams 210-d and transmit a channel state report to the base station 105-b indicating channel state information. In some examples, the base station 105-b may indicate a configuration for a channel state report setting associated with a number of bits. For example, the report may indicate a strongest beam. The UE 115-b and the base station 105-b may maintain or update communications over the communication link 125-b based on the report. For example, the base station 105-b and the UE 115-b may periodically perform a CSI-RS beam sweep and report procedure while in a connected mode. In some examples, the base station 105-b and the UE 115-b may perform a CSI-RS beam sweep and report procedure as part of a beam failure recovery procedure (e.g., to facilitate fast recovery) or a radio link failure procedure (e.g., as a last resort to re-establish communications).

The CSI-RS beam sweep may be a P1, P2, or P3 procedure. P1 may be a beam selection procedure where the base station 105-b sweeps the beam 210-d and the UE 115-a selects the strongest beam and reports the beam to the base station 105-b. P2 may be a beam refinement procedure for the base station 105-b, where the base station 105-b may refine a beam (e.g., via sweeping a narrower beam 210-d over a narrower range), and UE 115-b may detect and report the strongest beam to the base station 105-b. P3 may be a beam refinement procedure for the UE 115-b, where the base station 105-b may fix a beam (e.g., transmit a same beam 210-d repeatedly), and UE 115-b may refine its receiver beam 210-d. For example, the UE 115-b may set the spatial filter on the antenna array of the UE 115-b. The UE 115-b may transmit an L1 report for beam refinement. The base station 105-b and the UE 115-b may perform same process for uplink beam management (e.g., U1, U2, and U3).

The UE 115-b may report SSB resource block indicator (SSBRI) and CSI-RS resource indicator (CRI) and L1 RSRP and L1 SINR via CSI reports. For example, the CSI report configuration for the UE 115-b may include the fields ReportQuantity=ssb-Index-RSRP or ssb-Index-SINR or cri-RSRP or cri-SINR for joint SSBRI/CRI and L1-RSRP/L1-SINR beam reporting. The UE 115-b may report a number of different SSBRIs or CRIs for each CSI report configuration, where the number may be equal to the number of reported reference signals (which may be configured via radio resource control (RRC), and may be up to two or four depending on the capability of the UE 115-b).

For L1 RSRP reporting, for the strongest SSBRI, 7 bits may be used to report the RSRP in the range of [−140, −44] dBm with a 1 dBm step size. For the remaining SSBRIs or CRIs, 4 bits may be used to report a differential RSRP in the range of [0, −30] dB with a 2 dB step size and a reference to the strongest SSBRI or CRI's L1 RSRP. For the strongest SSBRI or CRI's L1 RSRP, there are invalid code points as 2⁷=128, but 140−44+1=97.

For L1 SINR reporting, for the strongest SSBRI or CRI, 7-bits may be used to report SINR in the range of [−23, 40] dB with a 0.5 dB step size. For the remaining SSBRI(s) or CRI(s), 4-bits may be used to report a differential SINR in the range of [0, −15] dB with a 1 dB step size and a reference to the strongest SSBRI or CRI's L1-SINR. For the strongest and the remaining SSBRI(s) or CRI(s), there may be no invalid code points, but SINR_0 may represent SINR<−23 dB for the strongest SSBRI or CRI, while DIFFSINR_15 may represent ΔSINR<−15 dB.

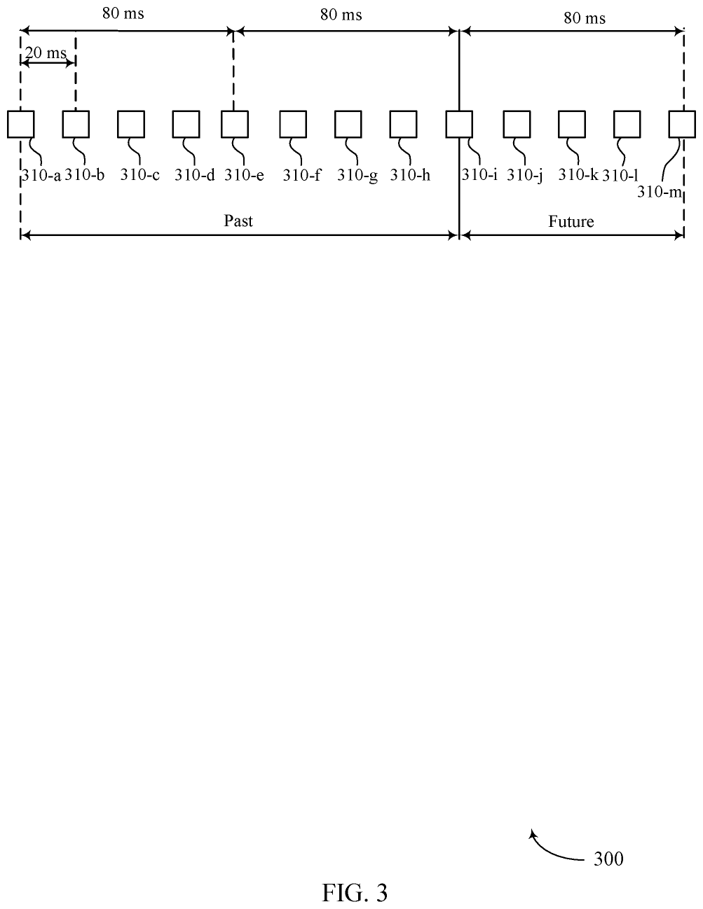

FIG. 3 illustrates an example of a timing diagram 300 that supports beam change reporting via prediction based beam management in accordance with aspects of the present disclosure. In some examples, the timing diagram 300 may be implemented by or may implement aspects of the wireless communications system 100, the wireless communications system 200, or the wireless communications system 205 as described with reference to FIGS. 1, 2a, and 2b.

In some examples, a UE 115 may be configured to transmit a beam report 310 periodically (e.g., every 20 ms, 40 ms, 80 ms, etc.). Frequent beam management and transmission of beam reports (e.g., every 20 ms or 40 ms) may consume UE-specific overhead and UE power. In many stationary or low speed scenarios, the top beam index may not change over hundreds of ms, therefore a UE 115 may reduce overhead and/or power consumption by predicting a beam change at the UE and transmitting a beam report either less frequently or on demand. A UE 115 may use an artificial intelligence based beam prediction which may predict the future top beam index or the probability of a future top beam change (e.g., via convolutional neural network (CNN), recurrent neural network (RNN), Long Short-Term Memory (LSTM), or the like). The UE 115 may predict whether the top beam index may change (or change more dynamically) at a future time (or a future time window) with increased beam management periodicity (e.g., hundreds of ms instead of 20 ms) and/or a reduced number of CSI-RS or SSB resources (e.g., using 4 measured beams to predict a top beam out of 32 potential beams).

For example, at the time of beam report 310-i, the UE 115 may predict future top beam indices 310-j, 310-k, 310-l, and/or 310-m based on the past measured top beam indices 310-a, 310-b, 310-c, 310-d, 310-e, 310-f, 310-g, and/or 310-h.

In some examples, the UE 115 may send requests to the base station 105 for decreased beam management periodicity or an increased number of CSI-RS/SSB resources if the top beam index is predicted to change or predicted to change more dynamically. In some cases, the beam management procedures with the fields ssb-Index-RSRP or cri-RSRP reporting may be suspended if the UE 115 identifies a stationary condition.

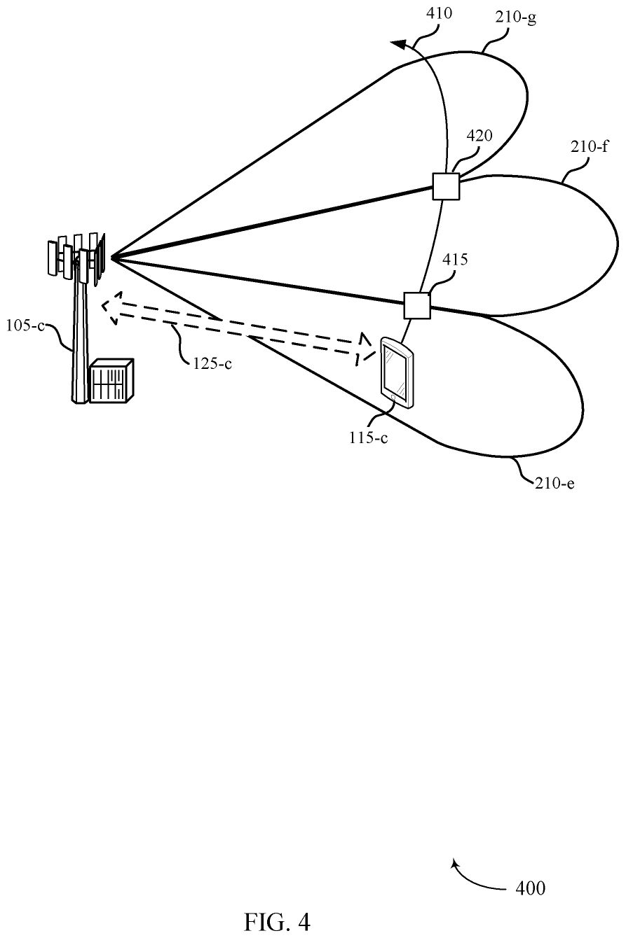

FIG. 4 illustrates an example of a wireless communications system 400 that supports beam change reporting via prediction based beam management in accordance with aspects of the present disclosure. In some examples, the wireless communications system 400 may be implemented by or may implement aspects of the wireless communications system 100, the wireless communications system 200, or the wireless communications system 205 as described with reference to FIGS. 1, 2a, and 2b. The wireless communications system 205 may include a UE 115-c which may be an example of a UE 115 as described herein. The wireless communications system 400 may also include a base station 105-c which may be an example of a base station 105 as described herein.

In some examples, the base station 105-c may communicate with the UE 115-c using directional communications techniques. For example, the base station 105-c may communicate with the UE 115-c via one or more beams 210. The base station 105-c may communicate with the UE 115-c via a communication link 125-c, which may be an example of an NR or LTE link between the UE 115-c and the base station 105-c. In some cases, the communication link 125-c may include an example of an access link (e.g., Uu link). The communication link 125-c may include a bi-directional link that enables both uplink and downlink communication. For example, the UE 115-c may transmit uplink signals, such as uplink control signals or uplink data signals, to the base station 105-c using the first communication link 125-c and the base station 105-c may transmit downlink signals, such as downlink control signals or downlink data signals, to the first UE 115-c using the communication link 125-c.

As the UE 115-c moves along a path 410, the strongest beam 210 may change. For example, at point 415, the strongest beam may change from beam 210-e to beam 210-f, and at point 420, the strongest beam may change from beam 210-f to beam 210-g. When the UE 115-c moves along the path 410 at a slow speed (e.g., if an operator is walking), the beams may largely be stationary (e.g., at a 20 ms beam management cycle, the strongest beam may be unchanged in 90% of the beam management reports). Some joint SSBRI and CRI and L1 RSRP and SINR reporting configurations may not allow requests for increased or decreased beam management periodicity in the CSI report (e.g., increased or decreased CSI report and CSI-RS periodicity). Some joint SSBRI and CRI and L1 RSRP and SINR reporting configurations may not allow requests for increased or decreased number of CSI-RS semi-persistent scheduling (SPS) or persistent scheduling (PS) SSB resources. Some joint SSBRI and CRI and L1 RSRP and SINR reporting configurations may not allow reporting of predicted beam change incidents.

Some enhanced SSBRI and CRI and L1 RSRP and SINR reporting configurations may enable a UE 115-c to jointly indicate L1 RSRP and SINR and additional parameters such as an increased or decreased beam management periodicity, or additional reporting quantities such as CSI-RS SPS or PS SSB resources. For example, a UE 115-c may request to report this additional information based on a predicted beam change event. UE overhead may not increase significantly with an enhanced SSBRI and CRI and L1 RSRP and SINR reporting configuration based on predicted beam changes.

In some examples, the UE 115-c may be configured with a PS or SPS CSI report configuration including a field reportQuantity including at least one of the following, where the number of bits in the CSI report is consistent: 1) either the fields ssb-Index-RSRP, ssb-Index-SINR, cri-RSRP, or cri-SINR (e.g., the first option); or 2) at least one additional reporting quantity other than the fields ssb-Index-RSRP, ssb-Index-SINR, cri-RSRP, or cri-SINR or changing the parameters associated with the CSI report configurations based on a beam change prediction (e.g., the second option). The UE 115-c may transmit a request to update the parameter in the field reportQuantity. For the second option, a configurable parameter may include a request to increase or decrease the CSI report periodicity. For the second option, a configurable parameter may include requests to trigger one or more additional dynamic, PS, or SPS CSI reports. For the second option, a configurable parameter may include a request to decrease the number of CSI-RS or SSB resources associated with the CSI report configuration. In some examples, the UE 115-c may report a predicted beam change incident, which may suggest the top beam index is predicted by the UE 115-c to change more dynamically as compared to previously reported top beam indices. In some examples, the base station 105-c may implicitly interpret whether the UE 115-c transmits a request to update the parameter in the field reportQuantity (e.g., the request to update the parameter in the field reportQuantity may be indicated in the CSI report).

In some examples, the UE 115-c may implicitly indicate a beam change prediction without introducing additional bits into a payload of the CSI report. For example, a payload size of the CSI report may be the same when reporting SSBRI or CRI and L1 RSRP and SINR. In some examples, the UE 115-c may use a first set of predetermined L1 RSRP or SINR code points to indicate that the reported CSI payload should be reinterpreted by the base station 105-c. For example, one or all of a request to increase or decrease the CSI report periodicity, a request for one or more additional PS or SPS CSI reports, a request to decrease the number of CSI-RS or SSB resources associated with the CSI report configuration, or a predicted beam change incident (collectively the second options), may be identified from the re-interpreted CSI report payload, and the SSBRI or CRI and L1 RSRP or SINR quantities may be identified differently compared to prior to the reinterpretation (e.g., a legacy SSBRI or CRI and L1 RSRP or SINR report). When the reported L1 RSRP or SINR code points in a CSI report are not part of the first set of predetermined code points, the CSI payload may be interpreted as a legacy SSBRI or CRI and L1 RSRP or SINR report.

In some examples, the first set of predetermined code points may be the invalid code points for the strongest SSBRI or CRI's L1 RSRP. For example, Table 1 below shows an example SSBRI or CRI and L1 RSRP or SINR report indicating to reinterpret the CSI report payload, where RSRP_1 for RSRP #1 field may be an invalid code point.

TABLE 1

| SSBRI#1 | RSRP#1 | SSBRI#2 | RSRP#2 |
|---|---|---|---|
| #1 | RSRP_1 | #3 | DIFFRSRP_1 |

In some examples, the first set of predetermined code points may be configured by the base station 105-c or pre-configured (e.g., standardized). For example, the base station 105-c may reinterpret the CSI report payload when the UE 115-c reports the strongest SSBRI or CRI's L1-SINR is SINR_0 (e.g., SINR<−23 dB). In some examples, the base station 105-c may reinterpret the CSI report payload when the UE 115-c reports at least one of the differential SINRs leads to a value lower than a predetermined threshold (e.g., <−20 dB) (e.g., because a low SINR may lead to low performance).

In some examples, the base station 105-c may reinterpret the CSI report payload based on the bits indicating the L1 RSRP or SINR code points themselves (e.g., based on the first set of predetermined code points. In some examples, the base station 105-c may reinterpret the CSI report payload based on the bits in the CSI report payload other than the first set of predetermined code points.

In some examples, multiple L1 RSRP or SINR code points in the first set of predetermined code points may represent different reinterpretations of the CSI report payload. For example, the different L1 RSRP or SINR code points in the first set of predetermined code points may represent different options within the second options, different levels of requested CSI report periodicity increases or decreases, different levels of CSI-RS and SSB resource number increases or decreases, or different additional CSI reports requested to be triggered.

In some examples, when the parameter in the field nrofReportedRS>1 in the CSI report configuration, the first top SSBRI or CRI may be used for identifying the second options based on the first set of predetermined code points. If the first set of predetermined code points includes a top beam RSRP code point, then the second top beam SSBRI or CRI's RSRP or SINR (indicated with 4 bits) may become the first top beam reported. In some examples, the second top beam SSBRI or CRI's RSRP or SINR may be reinterpreted based on an absolute RSRP instead of a differential RSRP and with a different range or step size as compared to the top beam report (with 7 bits). For example, as shown in Table 2 below, where RSRP #1 having a value of RSRP_1 triggers the reinterpretation, the RSRP #2 having a value of DIFFRSRP_9 may be reinterpreted as an absolute value of the RSRP with a different range or step size as compared to the top beam report.

TABLE 2

| SSBRI#1 | RSRP#1 | SSBRI#2 | RSRP#2 |
|---|---|---|---|
| #1 | RSRP_1 | #3 | DIFFRSRP_9 |

In some examples, the second top beam SSBRI or CRI's RSRP or SINR may be reinterpreted based on a differential RSRP, but with reference to the first top RSRP or SINR in the most recent CSI report instance. For example, as shown in table 4 below, where RSRP #1 having a value of RSRP_1 triggers the reinterpretation, the RSRP #2 having a value of DIFFRSRP_1 may be interpreted as a differential RSRP with reference to the RSRP #1 having a value of RSRP_75 in Table 3 which may be from a last (prior) beam report.

TABLE 3

| SSBRI#1 | RSRP#1 | SSBRI#2 | RSRP#2 |
|---|---|---|---|
| #1 | RSRP_75 | #3 | DIFFRSRP_1 |

TABLE 4

| SSBRI#1 | RSRP#1 | SSBRI#2 | RSRP#2 |
|---|---|---|---|
| #1 | RSRP_1 | #3 | DIFFRSRP_1 |

In some examples, the second top beam SSBRI or CRI's RSRP or SINR may be reinterpreted based on a differential RSRP and with reference to the first top RSRP or SINR code point indicated in the same report instance. The differential reference may include a different range or a greater step size as compared to the top beam report. For example, although the top beam RSRP or SINR code point indicated in the same report instance may be invalid (e.g., −43 dBm code point), the top beam RSRP or SINR code point indicated in the same report instance may indicate a valid value for layer 3 RSRP, and the differential reference may be based on that value (potentially with a greater step size). For example, with reference to Table 5 below, where RSRP #1 having a value of RSRP_114 triggers the reinterpretation, the RSRP #2 having a value of DIFFRSRP_9 may be a differential RSRP with reference to the RSRP #1 having a value of RSRP_114.

TABLE 5

| SSBRI#1 | RSRP#1 | SSBRI#2 | RSRP#2 |
|---|---|---|---|
| #1 | RSRP_114 | #3 | DIFFRSRP_9 |

When the CSI payload is re-interpreted to identify at least one of the second options, the reported SSBRI or CRI and L1 RSRP or SINR may be identified with a smaller number bits as compared to the cases where the reported CSI payload is not re-interpreted to identify the second options. The reinterpretation schemes may be based on a base station configuration, a standard predefinition, or a set of code points. In some examples, if the number of reported reference signals is greater than one, the reinterpretation schemes may further be based on dropping at least one of the SSBRIs or CRIs or L1 RSRPs or SINRs which is not associated with the top beam index dropped from the reported CSI payload. The SSBRIs or CRIs or L1 RSRPs or SINRs to drop may be based on a base station configuration, a standard predefinition, or a set of code points.

In some examples, the range of one or more of the reported L1 RSRPs/SINRs may be smaller as compared to the case where the reported CSI payload is not re-interpreted to identify the second options. In some examples, the smaller range may be based on a base station configuration, a standard predefinition, or a set of code points. In some examples, L1 RSRPs or SINRs associated with different SSBRIs or CRIs may include different smaller ranges (e.g., the smaller range may be applied to a number of L1 RSRPs or SINRs not associated with the strongest beam index. In some examples, the step size of one or more of the reported L1 RSRPs or SINRs may be greater as compared to the case where the reported CSI payload is not re-interpreted to identify the second options. In some examples, the greater step size may be based on a base station configuration, a standard predefinition, or a set of code points. In some examples, L1 RSRPs or SINRs associated with different SSBRIs or CRIs may include different greater step sizes (e.g., the greater step size may be applied to a number of L1 RSRPs or SINRs not associated with the strongest beam index).

In some examples, an additional bit in the CSI report payload may be introduced for indicating the second options. The UE 115-c may use the additional bit to identify the reinterpretation scheme of the reported CSI report payload such that one or all of the second options may be identified from the re-interpreted CSI report payload and the SSBRI or CRI and L1 RSRP or SINR reporting quantities may be identified differently as compared to the cases where reinterpretation is not indicated. In some examples, if the additional bit is set to “0” the base station 105-c may interpret that the SSBRI or CRI and L1 RSRP or SINR should be interpreted as legacy SSBRI or CRIs and L1 RSRP or SINR. In some examples, the reinterpretation may be based on the bits in the CSI report payload other than the additional bit. In some example, the additional bit may indicate the reinterpretation. For example, a “1” may indicate a request for decreasing the CSI report periodicity and a “0” may indicate a request to fallback to the originally configured CSI report periodicity. As another example, a “1” may indicate a request for an additional CSI report and a “0” may indicate a request to fallback to the originally configured CSI report periodicity.

In some examples, request(s) to increase or decrease the CSI report periodicity may be associated with the CSI report configuration. In some examples, the request may be indicated by single bit indicating whether the request is to increase or decrease the periodicity. In some examples, the request may be indicated by indicating a request to decrease the periodicity via a predetermined code point. In some examples, the request may be indicated by indicating on one or multiple bits a periodicity option selected from multiple periodicity options configured by the base station 105-c.

In some examples, the UE 115-c may request to trigger one or more additional dynamic, PS, or SPS CSI reports. In some examples, the UE 115-c may indicate the request to trigger one or more additional PS or SPS CSI reports via indicating a CSI request field for aperiodic CSI report triggering. In some examples, the UE 115-c may indicate the request to trigger one or more additional PS or SPS CSI reports via indicating an index of the CSI report configuration. In some examples, the UE 115-c may indicate the request to trigger one or more additional PS or SPS CSI reports based on a single bit indicating two CSI request options.

In some examples, the UE 115-c may request to increase or decrease the number of CSI-RS or SSB resources associated with the CSI report configuration. In some examples, the UE 115-c may request to increase or decrease the number of CSI-RS or SSB resources associated with the CSI report configuration via a single bit indicating whether the request is for an increase or a decrease. In some examples, the UE 115-c may request to increase the number of CSI-RS or SSB resources associated with the CSI report configuration via a predetermined code point. In some examples, the UE 115-c may request to increase or decrease the number of CSI-RS or SSB resources associated with the CSI report configuration via indicating one or more selected indices of the field CSI-ResourceConfig from a number of indices configured by the base station 105-c. In some examples, the UE 115-c may indicate a specific number of CSI-RS or SSB resources selected from a set of numbers of CSI-RS or SSB resources configured by the base station 105-c.

In some examples, the UE 115-c may report a predicted beam change incident. In some examples, a predicted beam change incident may indicate that the top beam index is predicted to be changing more dynamically as compared to previously reported top beam indices. In some examples, the predicted beam change incident may be indicated via a single bit of the CSI report configured to indicate whether there is a beam change incident. In some examples, the predicted beam change incident may be indicated via a pre-determined code point.

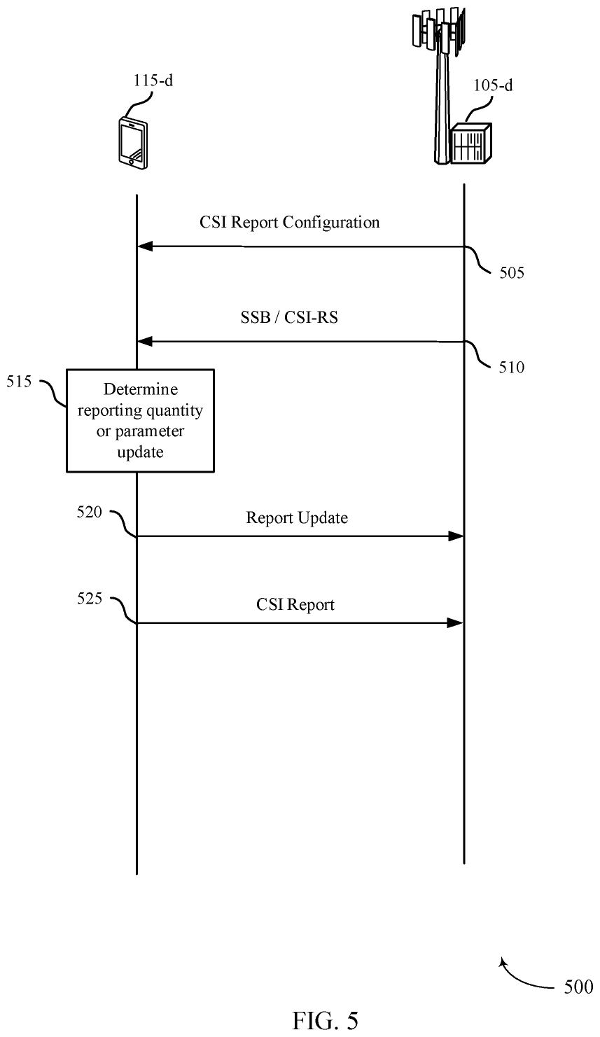

FIG. 5 illustrates an example of a process flow 500 that supports beam change reporting via prediction based beam management in accordance with aspects of the present disclosure. In some examples, the process flow 500 may be implemented by or may implement aspects of the wireless communications system 100, 200, 205, or 400. The process flow 500 may include a UE 115-d which may be an example of a UE 115 as described herein. The process flow 500 may also include a base station 105-d which may be an example of the base station 105 as described herein. In the following description of the process flow 500, the operations between the base station 105-d and the UE 115-d may be transmitted in a different order than the example order shown, or the operations performed by the base station 105-d and the UE 115-d may be performed in different orders or at different times. Some operations may also be omitted from the process flow 500, and other operations may be added to the process flow 500.

At 505, the UE 115-d may receive, from the base station 105-d, a message indicating a configuration for a channel state report setting, where the configuration for the channel state report setting is associated with a number of bits.

At 510, the base station 105-d may transmit a set of reference signals via a set of beams. For example, the base station 105-d set may transmit a set of SSB signals or CSI-RS via a set of beams. The UE 115-d may receive the set of signals and perform channel state measurements based on the received set of reference signals.

At 515, the UE 115-d may determine an updated reporting quantity for the channel state report setting or to change one or more parameters of the channel state report setting. In some examples, the UE 115-d may determine the updated reporting quantity for the channel state report setting or to change one or more parameters of the channel state report setting based on the received set of reference signals. In some examples, the additional reporting quantity may include an SSB index RSRP, an SSB index SINR, a channel state information resource indicator RSRP, or a channel state information resource indicator SINR

At 520, the UE 115-d may transmit, to the base station 105-d, a request for the additional reporting quantity for the channel state report setting or to change the one or more parameters of the channel state report setting.

At 525, the UE 115-d may transmit, to the base station 105-d, a channel state report using the number of bits and based on the configuration and the request.

In some examples, the UE 115-d may transmit, with the channel state report, a code point of a set of code points of a beam report, the code point indicating use of the additional reporting quantity for the channel state report setting or one or more changed parameters of the channel state report setting. In some examples, a first subset of the set of code points are configured for reporting a layer one RSRP of a received beam and a second subset of the set of code points are remaining code points, the remaining code points are invalid for reporting the layer one RSRP of the received beam, and transmitting the code point includes transmitting the code point that is selected from the second subset of the set of code points. In some examples, the UE 115-d may receive, from the base station 105-d, a message indicating a request configuration, where the request configuration includes an indication of the code point for indicating use of the additional reporting quantity for the channel state report setting or the one or more changed parameters of the channel state report setting. In some examples, the UE 115-d may transmit, with the request at 520, an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits. In some examples, different respective code points in the set of code points of the beam report may indicate use of different respective reporting quantities for the channel state report or different respective parameters for the channel state report.

In some examples, a beam report may include a first report for reporting a strongest beam in terms of either a layer one RSRP or a layer one SINR, and transmitting the request may include transmitting the request indicating to the base station 105-d to interpret a second report for reporting a second strongest beam in terms of either the layer one RSRP or the layer one SINR as reporting the strongest beam in terms of either the layer one RSRP or the layer one SINR. In some examples, transmitting the channel state report may include transmitting the second report indicating at least one of an absolute RSRP or an absolute SINR of the strongest beam, wherein a first step size associated with reporting the absolute RSRP or the absolute SINR of the strongest beam in the second report is different than a second step size associated with reporting a differential RSRP or a differential SINR of the strongest beam in the first report. In some examples, the UE 115-d may transmit, with the channel state report, the second report, where the second report indicates to the base station 105-d, based on the request, to interpret a previous strongest beam indicated by a previous first beam report in a previous channel state report as the strongest beam. In some examples, the UE 115-d may transmit, with the channel state report, the second report, where the second report indicates to the base station 105-d, based on the request, to interpret the first report as reporting the strongest beam according to an updated reporting configuration.

In some examples, transmitting the channel state report based on the configuration and the request includes transmitting a second set of beam reports using a second number of bits based on the request, where the second number of bits is less than a first number of bits configured for transmitting a first set of beam reports according to the configuration, and where the second set of beam reports includes the beam report. In some examples, the second set of beam reports includes less beam reports than the first set of beam reports. In some examples, each of the first set of beam reports and the second set of beam reports are associated with a respective range, and a second range of at least one beam report of the second set of beam reports is less than a first range of a corresponding beam report of the first set of beam reports. In some examples, each of the first set of beam reports and the second set of beam reports are associated with a respective step size, and a second step size of at least one beam report of the second set of beam reports is less than a first step size of a corresponding beam report of the first set of beam reports.

In some examples, the request may be transmitted with the channel state report. In some examples, transmitting the request may include, transmitting with the channel state report, a bit in addition to a payload of the channel state report, the bit indicating the request. In some examples, transmitting the channel state report may include indicating, via one or more bits associated with the payload of the channel state report, the additional reporting quantity for the channel state report or the one or more parameters of the channel state report. In some examples, transmitting the channel state report may include indicating, via one or more bits in addition to the payload of the channel state report, the additional reporting quantity for the channel state report or the one or more parameters of the channel state report. In some examples, transmitting the channel state report based on the configuration and the request includes transmitting a second set of beam reports using a second number of bits based on the request, where the second number of bits is less than a first number of bits configured for transmitting a first set of beam reports according to the configuration.

In some examples, transmitting the request at 520 may include transmitting an indication to change a periodicity associated with future channel state reports. In some examples, the configuration for the channel state report setting includes a set of scheduled channel state reports, and transmitting the request includes transmitting a message requesting am additional channel state report in addition to the set of scheduled channel state reports.

In some examples, transmitting the request at 520 may include transmitting a message requesting to change the one or more parameters, and the one or more parameters may include a number of CSI-RS resources associated with the channel state report setting or a number of SSB resources associated with the channel state report setting. In some examples, transmitting the request at 520 may include transmitting a message reporting a predicted beam change incident.

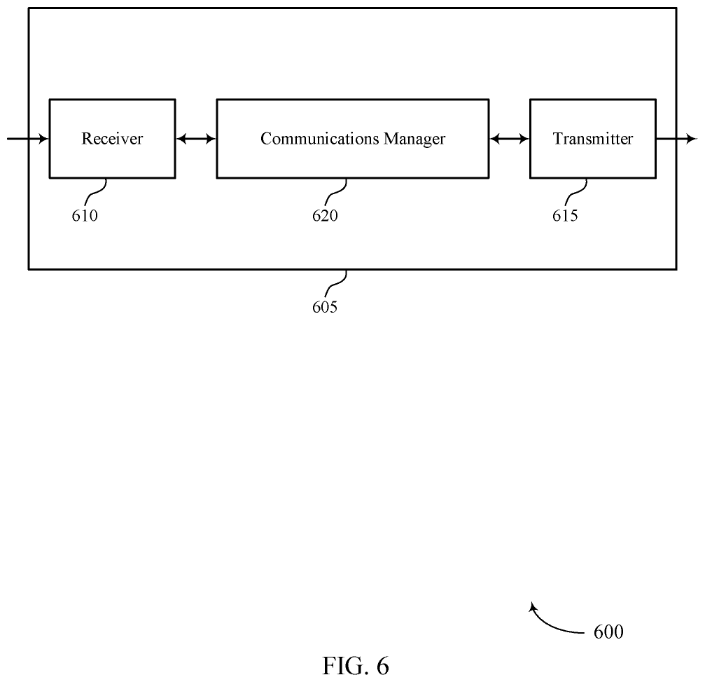

FIG. 6 shows a block diagram 600 of a device 605 that supports beam change reporting via prediction based beam management in accordance with aspects of the present disclosure. The device 605 may be an example of aspects of a UE 115 as described herein. The device 605 may include a receiver 610, a transmitter 615, and a communications manager 620. The device 605 may also include one or more processors, memory coupled with the one or more processors, and instructions stored in the memory that are executable by the one or more processors to enable the one or more processors to perform the beam change reporting via prediction based beam management features discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to beam change reporting via prediction based beam management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to beam change reporting via prediction based beam management). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of beam change reporting via prediction based beam management as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving, from a base station, a configuration for a channel state report setting, where the configuration for the channel state report setting is associated with a number of bits. The communications manager 620 may be configured as or otherwise support a means for transmitting, to the base station, a request for an additional reporting quantity for the channel state report setting or to change one or more parameters of the channel state report setting. The communications manager 620 may be configured as or otherwise support a means for transmitting, to the base station, a channel state report using the number of bits based on the configuration and the request.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced power consumption and more efficient utilization of communication resources by facilitating flexible beam management reporting.

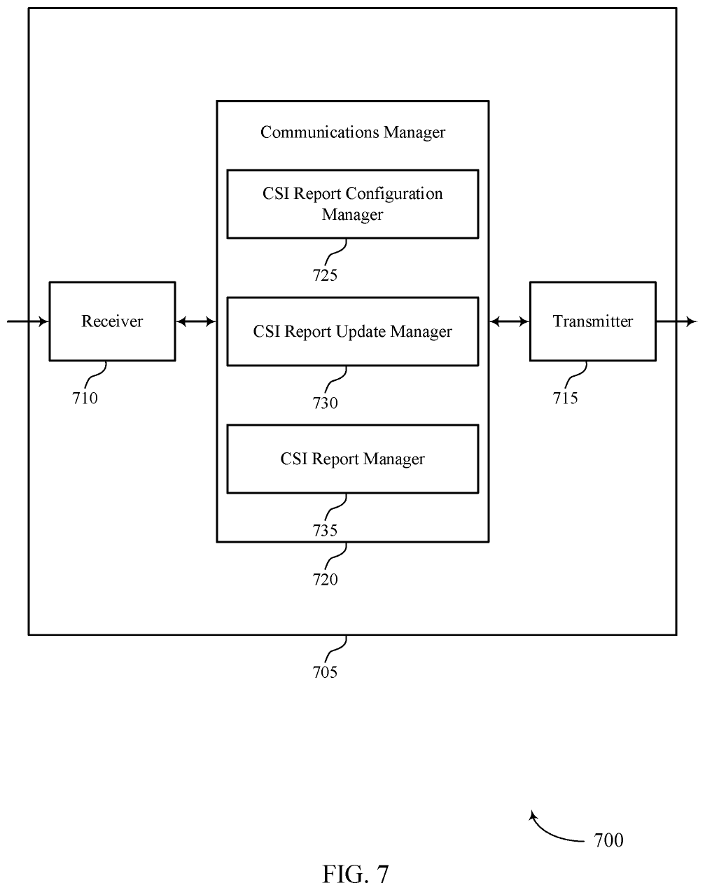

FIG. 7 shows a block diagram 700 of a device 705 that supports beam change reporting via prediction based beam management in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to beam change reporting via prediction based beam management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to beam change reporting via prediction based beam management). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of beam change reporting via prediction based beam management as described herein. For example, the communications manager 720 may include a CSI report configuration manager 725, a CSI report update manager 730, a CSI report manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The CSI report configuration manager 725 may be configured as or otherwise support a means for receiving, from a base station, a configuration for a channel state report setting, where the configuration for the channel state report setting is associated with a number of bits. The CSI report update manager 730 may be configured as or otherwise support a means for transmitting, to the base station, a request for an additional reporting quantity for the channel state report setting or to change one or more parameters of the channel state report setting. The CSI report manager 735 may be configured as or otherwise support a means for transmitting, to the base station, a channel state report using the number of bits based on the configuration and the request.

In some cases, the CSI report configuration manager 725, the CSI report update manager 730, and the CSI report manager 735 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the CSI report configuration manager 725, the CSI report update manager 730, and the CSI report manager 735 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

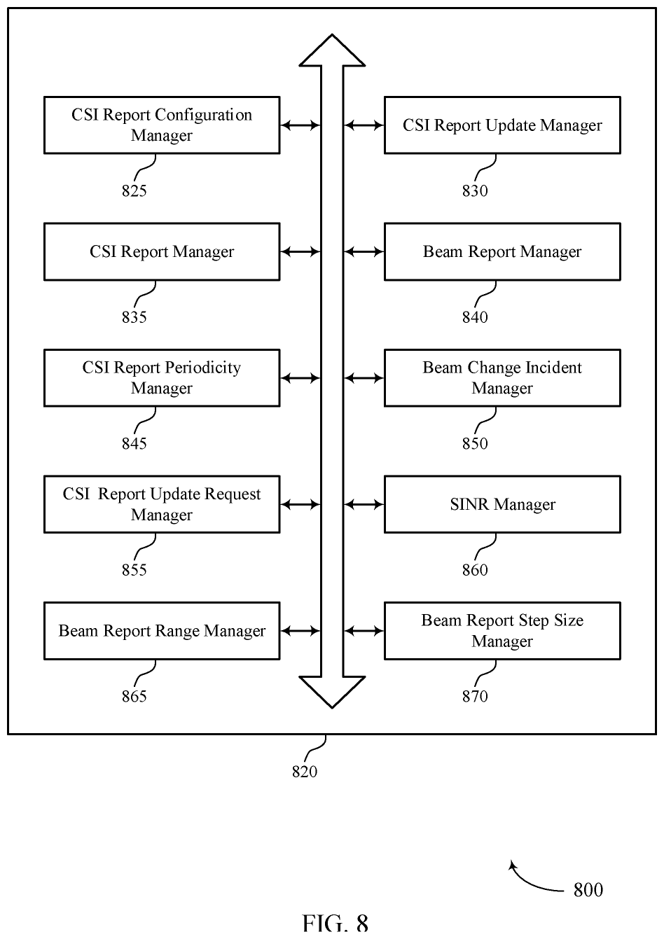

FIG. 8 shows a block diagram 800 of a communications manager 820 that supports beam change reporting via prediction based beam management in accordance with aspects of the present disclosure. The communications manager 820 may be an example of aspects of a communications manager 620, a communications manager 720, or both, as described herein. The communications manager 820, or various components thereof, may be an example of means for performing various aspects of beam change reporting via prediction based beam management as described herein. For example, the communications manager 820 may include a CSI report configuration manager 825, a CSI report update manager 830, a CSI report manager 835, a beam report manager 840, a CSI report periodicity manager 845, a beam change incident manager 850, a CSI report update request manager 855, an SINR manager 860, a beam report range manager 865, a beam report step size manager 870, or any combination thereof. Each of these components may communicate, directly or indirectly, with one another (e.g., via one or more buses).

The communications manager 820 may support wireless communications at a UE in accordance with examples as disclosed herein. The CSI report configuration manager 825 may be configured as or otherwise support a means for receiving, from a base station, a configuration for a channel state report setting, where the configuration for the channel state report setting is associated with a number of bits. The CSI report update manager 830 may be configured as or otherwise support a means for transmitting, to the base station, a request for an additional reporting quantity for the channel state report setting or to change one or more parameters of the channel state report setting. The CSI report manager 835 may be configured as or otherwise support a means for transmitting, to the base station, a channel state report using the number of bits based on the configuration and the request.

In some examples, to support transmitting the channel state report, the beam report manager 840 may be configured as or otherwise support a means for transmitting, with the channel state report, a code point of a set of code points of a beam report, indicating use of the additional reporting quantity for the channel state report setting or one or more changed parameters of the channel state report setting.

In some examples, to support transmitting the code point, the beam report manager 840 may be configured as or otherwise support a means for transmitting the code point that is selected from the second subset of the set of code points.

In some examples, the CSI report update request manager 855 may be configured as or otherwise support a means for receiving, from the base station, a message indicating a request configuration, where the request configuration includes an indication of the code point for indicating use of the additional reporting quantity for the channel state report setting or the one or more changed parameters of the channel state report setting.

In some examples, to support transmitting the request, the beam report manager 840 may be configured as or otherwise support a means for transmitting an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits.

In some examples, different respective code points in the set of code points of the beam report indicate use of different respective reporting quantities for the channel state report or different respective parameters for the channel state report.

In some examples, to support transmitting the request to the base station, the CSI report update manager 830 may be configured as or otherwise support a means for transmitting the request indicating to the base station to interpret a second report for reporting a second strongest beam in terms of either the layer one RSRP or the layer one SINR as reporting the strongest beam in terms of either the layer one RSRP or the layer one SINR.

In some examples, to support transmitting the channel state report, the SINR manager 860 may be configured as or otherwise support a means for transmitting the second report indicating at least one of an absolute RSRP or an absolute SINR of the strongest beam, where a first step size associated with reporting the absolute RSRP or the absolute SINR of the strongest beam in the second report is different than a second step size associated with reporting a differential RSRP or a differential SINR of the strongest beam in the first report.

In some examples, the beam report manager 840 may be configured as or otherwise support a means for transmitting, with the channel state report, the second report, where the second report indicates, based on the request, to interpret a previous strongest beam indicated by a previous first beam report in a previous channel state report as the strongest beam.

In some examples, the beam report manager 840 may be configured as or otherwise support a means for transmitting, with the channel state report, the second report, where the second report indicates, based on the request, to interpret the first report as reporting the strongest beam according to an updated reporting configuration.

In some examples, to support transmitting the channel state report based on the configuration and the request, the beam report manager 840 may be configured as or otherwise support a means for transmitting a second set of beam reports using a second number of bits based on the request, where the second number of bits is less than a first number of bits configured for transmitting a first set of beam reports according to the configuration, where the second set of beam reports includes the beam report.

In some examples, the second set of beam reports includes less beam reports than the first set of beam reports.

In some examples, each of the first set of beam reports and the second set of beam reports are associated with a respective range. In some examples, a second range of at least one beam report of the second set of beam reports is less than a first range of a corresponding beam report of the first set of beam reports.

In some examples, each of the first set of beam reports and the second set of beam reports are associated with a respective step size. In some examples, a second step size of at least one beam report of the second set of beam reports is less than a first step size of a corresponding beam report of the first set of beam reports.

In some examples, to support transmitting the request, the CSI report update manager 830 may be configured as or otherwise support a means for transmitting, with the channel state report, a bit in addition to a payload of the channel state report, the bit indicating the request.

In some examples, to support transmitting the channel state report, the CSI report update manager 830 may be configured as or otherwise support a means for indicating, via one or more bits associated with the payload of the channel state report, the additional reporting quantity for the channel state report or the one or more parameters of the channel state report.

In some examples, to support transmitting the channel state report, the CSI report update manager 830 may be configured as or otherwise support a means for indicating, via one or more bits in addition to the payload of the channel state report, the additional reporting quantity for the channel state report or the one or more parameters of the channel state report.

In some examples, to support transmitting the channel state report based on the configuration and the request, the beam report manager 840 may be configured as or otherwise support a means for transmitting a second set of beam reports using a second number of bits based on the request, where the second number of bits is less than a first number of bits configured for transmitting a first set of beam reports according to the configuration.

In some examples, to support transmitting the request, the CSI report periodicity manager 845 may be configured as or otherwise support a means for transmitting an indication to change a periodicity associated with future channel state reports.

In some examples, to support transmitting the request, the CSI report update manager 830 may be configured as or otherwise support a means for transmitting a message requesting a second channel state report in addition to the set of scheduled channel state reports.

In some examples, transmitting the request includes transmitting a message requesting to change the one or more parameters. In some examples, the one or more parameters include a number of CSI-RS resources associated with the channel state report setting or a number of SSB resources associated with the channel state report setting.

In some examples, to support transmitting the request, the beam change incident manager 850 may be configured as or otherwise support a means for transmitting a message reporting a predicted beam change incident.

In some examples, the additional reporting quantity includes an SSB index RSRP, an SSB index SINR, a channel state information resource indicator RSRP, or a channel state information resource indicator SINR.

In some cases, the CSI report configuration manager 825, the CSI report update manager 830, the CSI report manager 835, the beam report manager 840, the CSI report periodicity manager 845, the beam change incident manager 850, the CSI report update request manager 855, the SINR manager 860, the beam report range manager 865, and the beam report step size manager 870 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the CSI report configuration manager 825, the CSI report update manager 830, the CSI report manager 835, the beam report manager 840, the CSI report periodicity manager 845, the beam change incident manager 850, the CSI report update request manager 855, the SINR manager 860, the beam report range manager 865, and the beam report step size manager 870 discussed herein.

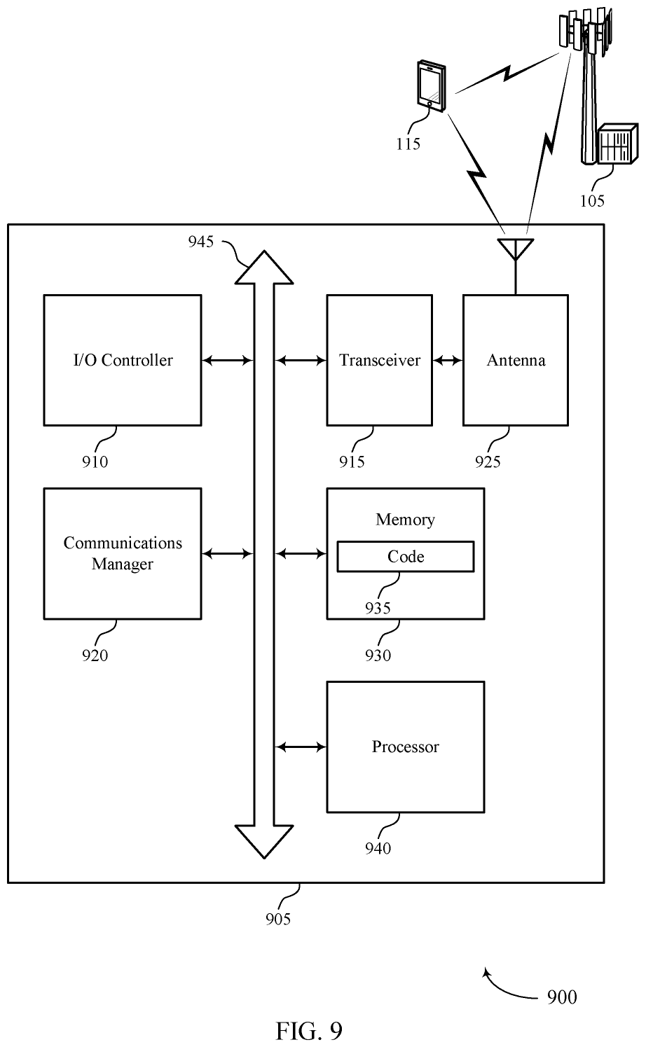

FIG. 9 shows a diagram of a system 900 including a device 905 that supports beam change reporting via prediction based beam management in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting beam change reporting via prediction based beam management). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a base station, a configuration for a channel state report setting, where the configuration for the channel state report setting is associated with a number of bits. The communications manager 920 may be configured as or otherwise support a means for transmitting, to the base station, a request for an additional reporting quantity for the channel state report setting or to change one or more parameters of the channel state report setting. The communications manager 920 may be configured as or otherwise support a means for transmitting, to the base station, a channel state report using the number of bits based on the configuration and the request.

By including or configuring the communications manager 920 in accordance with examples as described herein, the device 905 may support techniques for reduced power consumption and more efficient utilization of communication resources by facilitating flexible beam management reporting.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of beam change reporting via prediction based beam management as described herein, or the processor 940 and the memory 930 may be otherwise configured to perform or support such operations.

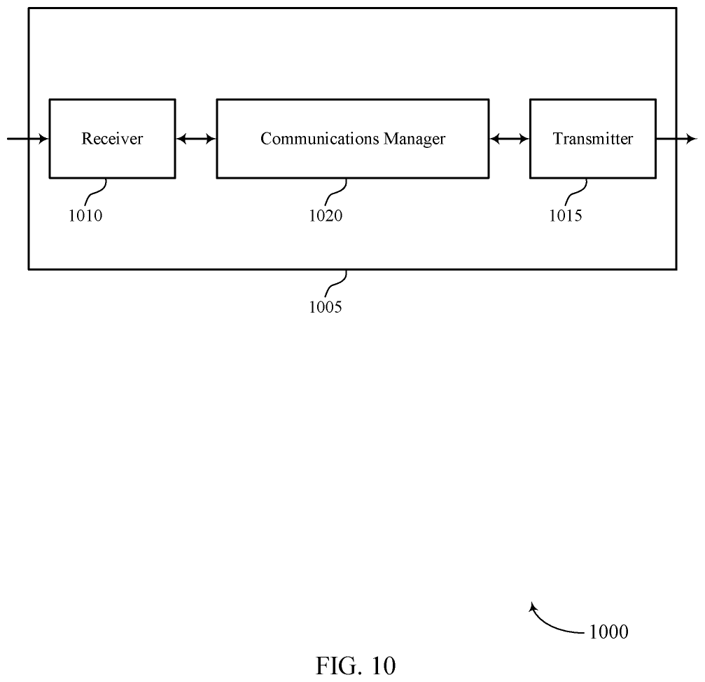

FIG. 10 shows a block diagram 1000 of a device 1005 that supports beam change reporting via prediction based beam management in accordance with aspects of the present disclosure. The device 1005 may be an example of aspects of a base station 105 as described herein. The device 1005 may include a receiver 1010, a transmitter 1015, and a communications manager 1020. The device 1005 may also include one or more processors, memory coupled with the one or more processors, and instructions stored in the memory that are executable by the one or more processors to enable the one or more processors to perform the beam change reporting via prediction based beam management features discussed herein. Each of these components may be in communication with one another (e.g., via one or more buses).

The receiver 1010 may provide a means for receiving information such as packets, user data, control information, or any combination thereof associated with various information channels (e.g., control channels, data channels, information channels related to beam change reporting via prediction based beam management). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to beam change reporting via prediction based beam management). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of beam change reporting via prediction based beam management as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, a configuration for a channel state report setting, where the configuration for the channel state report setting is associated with a number of bits. The communications manager 1020 may be configured as or otherwise support a means for receiving, from the UE, a request for an additional reporting quantity for the channel state report setting or to change one or more parameters of the channel state report setting. The communications manager 1020 may be configured as or otherwise support a means for receiving, from the UE, a channel state report using the number of bits based on the configuration and the request.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced power consumption and more efficient utilization of communication resources by facilitating flexible beam management reporting.

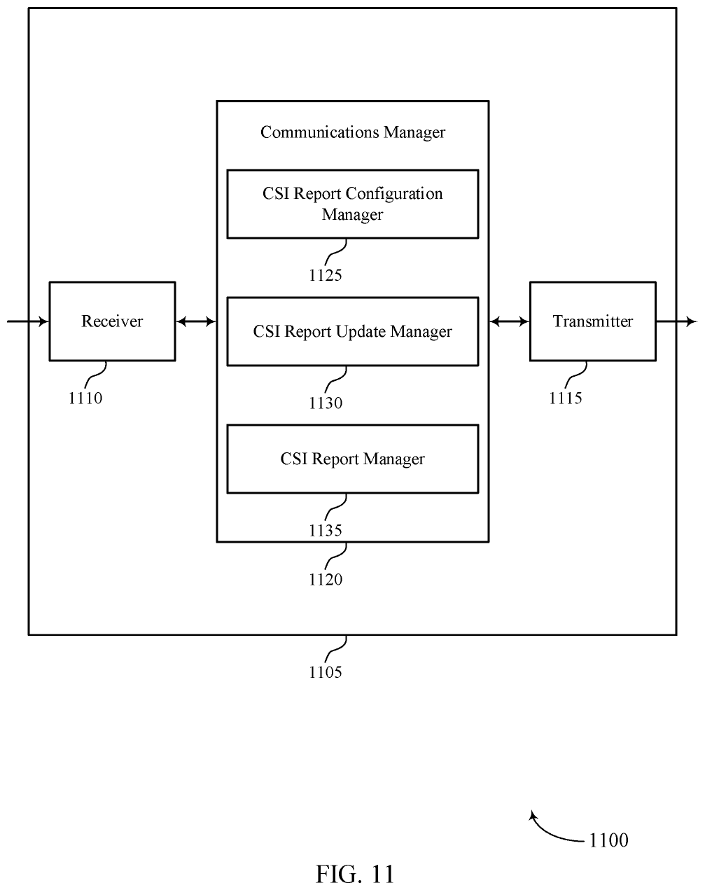

FIG. 11 shows a block diagram 1100 of a device 1105 that supports beam change reporting via prediction based beam management in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to beam change reporting via prediction based beam management). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to beam change reporting via prediction based beam management). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of beam change reporting via prediction based beam management as described herein. For example, the communications manager 1120 may include a CSI report configuration manager 1125, a CSI report update manager 1130, a CSI report manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The CSI report configuration manager 1125 may be configured as or otherwise support a means for transmitting, to a UE, a configuration for a channel state report setting, where the configuration for the channel state report setting is associated with a number of bits. The CSI report update manager 1130 may be configured as or otherwise support a means for receiving, from the UE, a request for an additional reporting quantity for the channel state report setting or to change one or more parameters of the channel state report setting. The CSI report manager 1135 may be configured as or otherwise support a means for receiving, from the UE, a channel state report using the number of bits based on the configuration and the request.

In some cases, the CSI report configuration manager 1125, the CSI report update manager 1130, and the CSI report manager 1135 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the CSI report configuration manager 1125, the CSI report update manager 1130, and the CSI report manager 1135 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

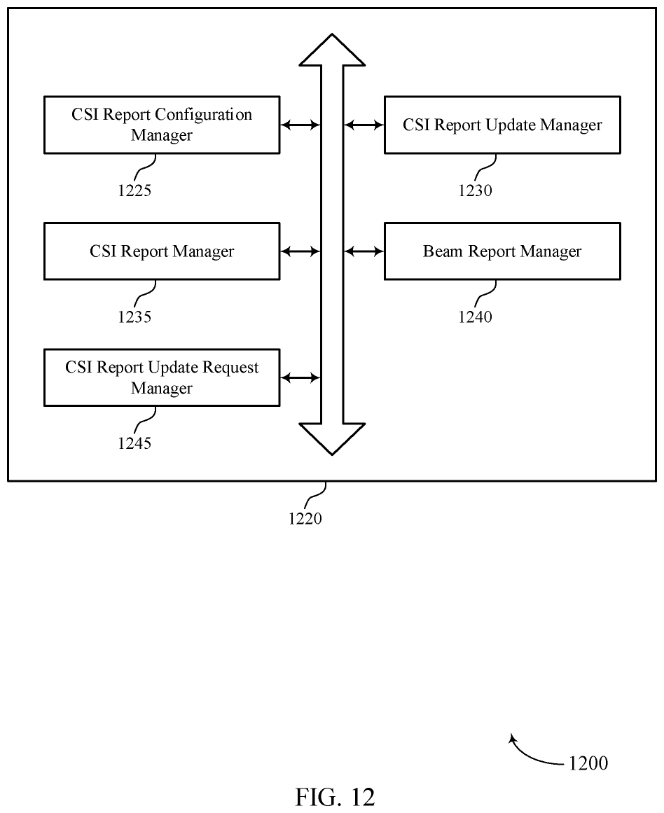

FIG. 12 shows a block diagram 1200 of a communications manager 1220 that supports beam change reporting via prediction based beam management in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of beam change reporting via prediction based beam management as described herein. For example, the communications manager 1220 may include a CSI report configuration manager 1225, a CSI report update manager 1230, a CSI report manager 1235, a beam report manager 1240, a CSI report update request manager 1245, or any combination thereof. Each of these components may communicate, directly or indirectly, with one another (e.g., via one or more buses).

The communications manager 1220 may support wireless communications at a base station in accordance with examples as disclosed herein. The CSI report configuration manager 1225 may be configured as or otherwise support a means for transmitting, to a UE, a configuration for a channel state report setting, where the configuration for the channel state report setting is associated with a number of bits. The CSI report update manager 1230 may be configured as or otherwise support a means for receiving, from the UE, a request for an additional reporting quantity for the channel state report setting or to change one or more parameters of the channel state report setting. The CSI report manager 1235 may be configured as or otherwise support a means for receiving, from the UE, a channel state report using the number of bits based on the configuration and the request.

In some examples, to support receiving the request, the beam report manager 1240 may be configured as or otherwise support a means for receiving, with the channel state report, a code point of a set of code points of a beam report, indicating use of the additional reporting quantity for the channel state report setting or one or more changed parameters of the channel state report setting.

In some examples, to support receiving the code point, the beam report manager 1240 may be configured as or otherwise support a means for receiving the code point that is selected from the second subset of the set of code points.

In some examples, the CSI report update request manager 1245 may be configured as or otherwise support a means for transmitting, to the UE, a message indicating a request configuration, where the request configuration includes an indication of the code point for indicating use of the additional reporting quantity for the channel state report setting or the one or more changed parameters of the channel state report setting.

In some examples, to support receiving the request, the beam report manager 1240 may be configured as or otherwise support a means for receiving an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits.

In some cases, the CSI report configuration manager 1225, the CSI report update manager 1230, the CSI report manager 1235, the beam report manager 1240, and the CSI report update request manager 1245 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the CSI report configuration manager 1225, the CSI report update manager 1230, the CSI report manager 1235, the beam report manager 1240, and the CSI report update request manager 1245 discussed herein.

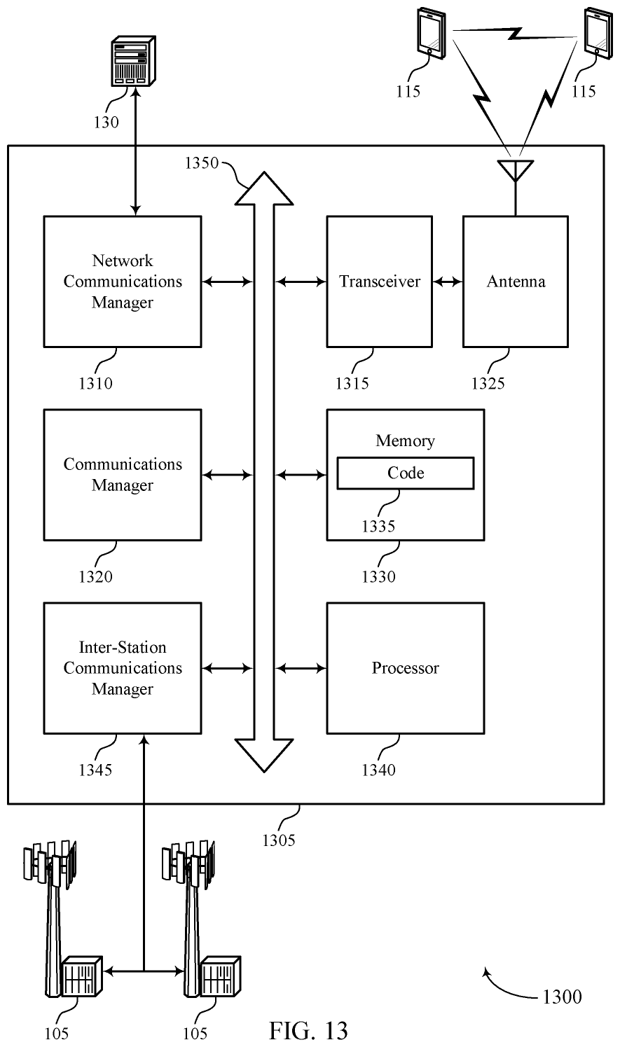

FIG. 13 shows a diagram of a system 1300 including a device 1305 that supports beam change reporting via prediction based beam management in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting beam change reporting via prediction based beam management). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, a configuration for a channel state report setting, where the configuration for the channel state report setting is associated with a number of bits. The communications manager 1320 may be configured as or otherwise support a means for receiving, from the UE, a request for an additional reporting quantity for the channel state report setting or to change one or more parameters of the channel state report setting. The communications manager 1320 may be configured as or otherwise support a means for receiving, from the UE, a channel state report using the number of bits based on the configuration and the request.

By including or configuring the communications manager 1320 in accordance with examples as described herein, the device 1305 may support techniques for reduced power consumption and more efficient utilization of communication resources by facilitating flexible beam management reporting.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of beam change reporting via prediction based beam management as described herein, or the processor 1340 and the memory 1330 may be otherwise configured to perform or support such operations.

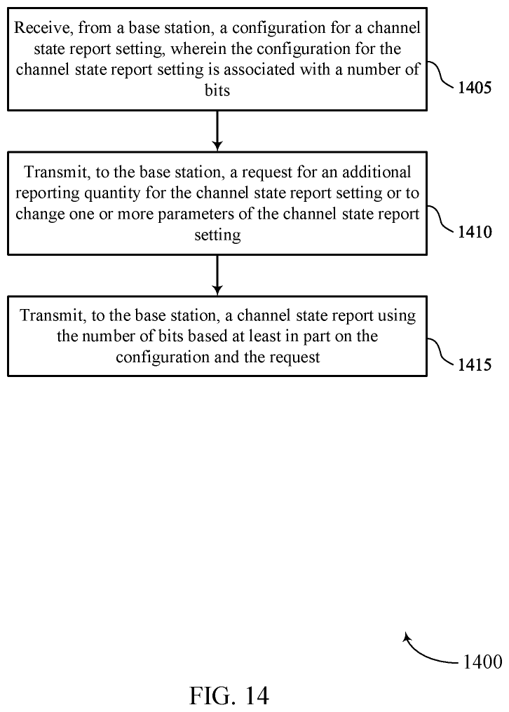

FIG. 14 shows a flowchart illustrating a method 1400 that supports beam change reporting via prediction based beam management in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, a configuration for a channel state report setting, where the configuration for the channel state report setting is associated with a number of bits. The operations of 1405 may be performed in accordance with examples as disclosed herein. In some examples, aspects of the operations of 1405 may be performed by a CSI report configuration manager 825 as described with reference to FIG. 8.

At 1410, the method may include transmitting, to the base station, a request for an additional reporting quantity for the channel state report setting or to change one or more parameters of the channel state report setting. The operations of 1410 may be performed in accordance with examples as disclosed herein. In some examples, aspects of the operations of 1410 may be performed by a CSI report update manager 830 as described with reference to FIG. 8.

At 1415, the method may include transmitting, to the base station, a channel state report using the number of bits based on the configuration and the request. The operations of 1415 may be performed in accordance with examples as disclosed herein. In some examples, aspects of the operations of 1415 may be performed by a CSI report manager 835 as described with reference to FIG. 8.

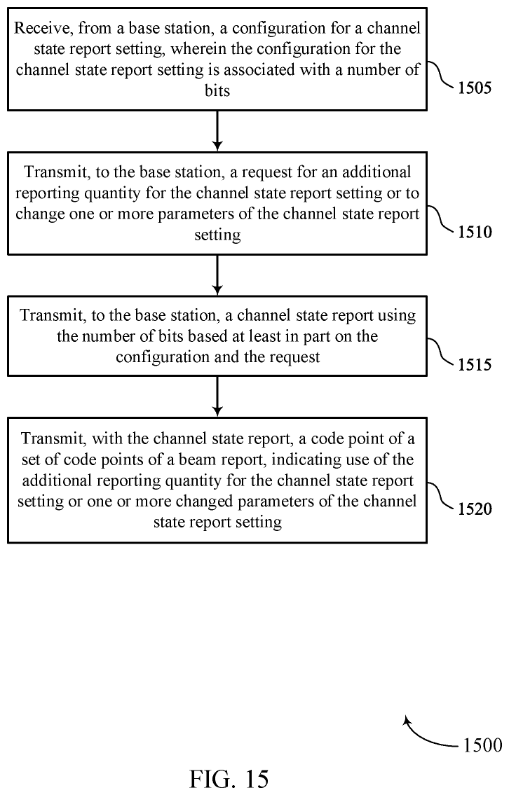

FIG. 15 shows a flowchart illustrating a method 1500 that supports beam change reporting via prediction based beam management in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a configuration for a channel state report setting, where the configuration for the channel state report setting is associated with a number of bits. The operations of 1505 may be performed in accordance with examples as disclosed herein. In some examples, aspects of the operations of 1505 may be performed by a CSI report configuration manager 825 as described with reference to FIG. 8.

At 1510, the method may include transmitting, to the base station, a request for an additional reporting quantity for the channel state report setting or to change one or more parameters of the channel state report setting. The operations of 1510 may be performed in accordance with examples as disclosed herein. In some examples, aspects of the operations of 1510 may be performed by a CSI report update manager 830 as described with reference to FIG. 8.

At 1515, the method may include transmitting, to the base station, a channel state report using the number of bits based on the configuration and the request. The operations of 1515 may be performed in accordance with examples as disclosed herein. In some examples, aspects of the operations of 1515 may be performed by a CSI report manager 835 as described with reference to FIG. 8.

At 1520, the method may include transmitting, with the channel state report, a code point of a set of code points of a beam report, indicating use of the additional reporting quantity for the channel state report setting or one or more changed parameters of the channel state report setting. The operations of 1520 may be performed in accordance with examples as disclosed herein. In some examples, aspects of the operations of 1520 may be performed by a beam report manager 840 as described with reference to FIG. 8.

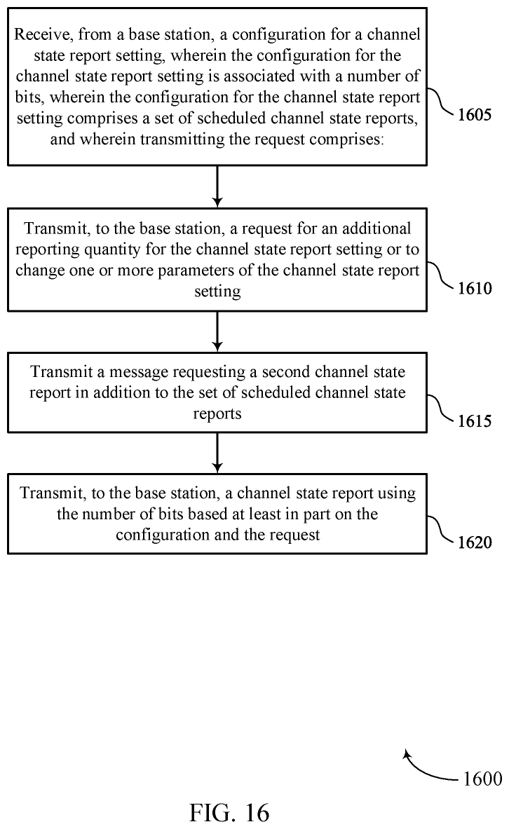

FIG. 16 shows a flowchart illustrating a method 1600 that supports beam change reporting via prediction based beam management in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, a configuration for a channel state report setting, where the configuration for the channel state report setting is associated with a number of bits. The operations of 1605 may be performed in accordance with examples as disclosed herein. In some examples, aspects of the operations of 1605 may be performed by a CSI report configuration manager 825 as described with reference to FIG. 8.

At 1610, the method may include transmitting, to the base station, a request for an additional reporting quantity for the channel state report setting or to change one or more parameters of the channel state report setting. The operations of 1610 may be performed in accordance with examples as disclosed herein. In some examples, aspects of the operations of 1610 may be performed by a CSI report update manager 830 as described with reference to FIG. 8.

At 1615, the method may include transmitting a message requesting a second channel state report in addition to the set of scheduled channel state reports. The operations of 1615 may be performed in accordance with examples as disclosed herein. In some examples, aspects of the operations of 1615 may be performed by a CSI report update manager 830 as described with reference to FIG. 8.

At 1620, the method may include transmitting, to the base station, a channel state report using the number of bits based on the configuration and the request. The operations of 1620 may be performed in accordance with examples as disclosed herein. In some examples, aspects of the operations of 1620 may be performed by a CSI report manager 835 as described with reference to FIG. 8.

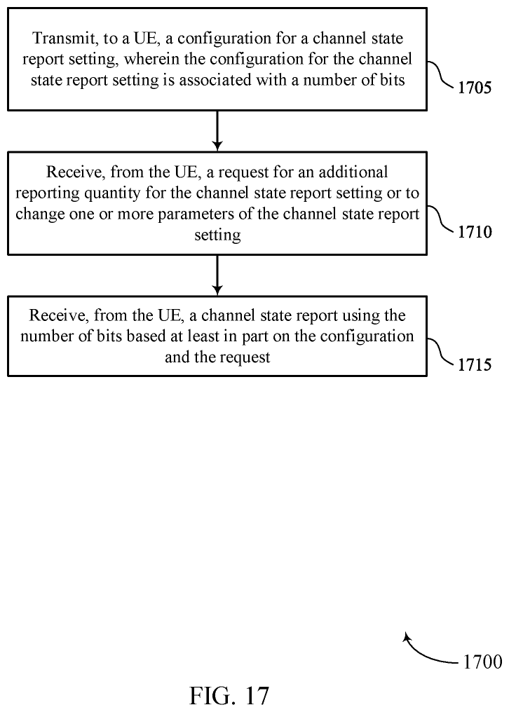

FIG. 17 shows a flowchart illustrating a method 1700 that supports beam change reporting via prediction based beam management in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, a configuration for a channel state report setting, where the configuration for the channel state report setting is associated with a number of bits. The operations of 1705 may be performed in accordance with examples as disclosed herein. In some examples, aspects of the operations of 1705 may be performed by a CSI report configuration manager 1225 as described with reference to FIG. 12.

At 1710, the method may include receiving, from the UE, a request for an additional reporting quantity for the channel state report setting or to change one or more parameters of the channel state report setting. The operations of 1710 may be performed in accordance with examples as disclosed herein. In some examples, aspects of the operations of 1710 may be performed by a CSI report update manager 1230 as described with reference to FIG. 12.

At 1715, the method may include receiving, from the UE, a channel state report using the number of bits based on the configuration and the request. The operations of 1715 may be performed in accordance with examples as disclosed herein. In some examples, aspects of the operations of 1715 may be performed by a CSI report manager 1235 as described with reference to FIG. 12.

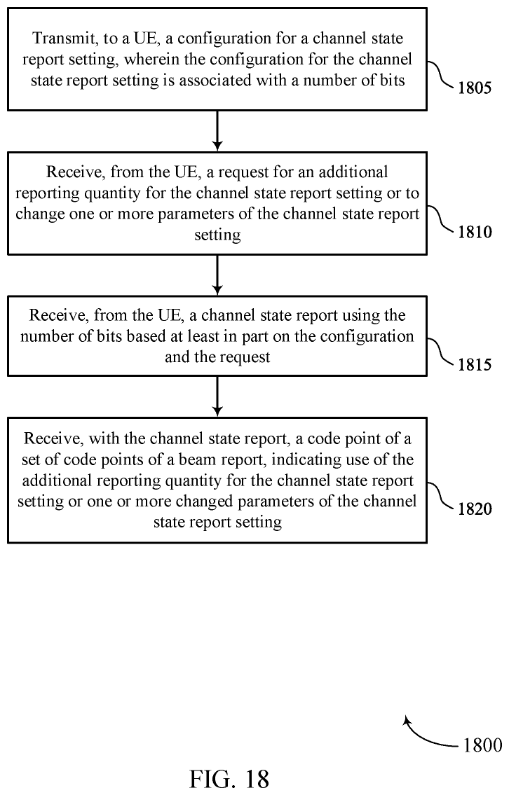

FIG. 18 shows a flowchart illustrating a method 1800 that supports beam change reporting via prediction based beam management in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, a configuration for a channel state report setting, where the configuration for the channel state report setting is associated with a number of bits. The operations of 1805 may be performed in accordance with examples as disclosed herein. In some examples, aspects of the operations of 1805 may be performed by a CSI report configuration manager 1225 as described with reference to FIG. 12.

At 1810, the method may include receiving, from the UE, a request for an additional reporting quantity for the channel state report setting or to change one or more parameters of the channel state report setting. The operations of 1810 may be performed in accordance with examples as disclosed herein. In some examples, aspects of the operations of 1810 may be performed by a CSI report update manager 1230 as described with reference to FIG. 12.

At 1815, the method may include receiving, from the UE, a channel state report using the number of bits based on the configuration and the request. The operations of 1815 may be performed in accordance with examples as disclosed herein. In some examples, aspects of the operations of 1815 may be performed by a CSI report manager 1235 as described with reference to FIG. 12.

At 1820, the method may include receiving, with the channel state report, a code point of a set of code points of a beam report, indicating use of the additional reporting quantity for the channel state report setting or one or more changed parameters of the channel state report setting. The operations of 1820 may be performed in accordance with examples as disclosed herein. In some examples, aspects of the operations of 1820 may be performed by a beam report manager 1240 as described with reference to FIG. 12.

The following provides an overview of aspects of the present disclosure:

Aspect 1: A method for wireless communications at a UE, comprising: receiving, from a base station, a configuration for a channel state report setting, wherein the configuration for the channel state report setting is associated with a number of bits; transmitting, to the base station, a request for an additional reporting quantity for the channel state report setting or to change one or more parameters of the channel state report setting; and transmitting, to the base station, a channel state report using the number of bits based at least in part on the configuration and the request.

Aspect 2: The method of aspect 1, wherein transmitting the channel state report comprises: transmitting, with the channel state report, a code point of a set of code points of a beam report, the code point indicating use of the additional reporting quantity for the channel state report setting or one or more changed parameters of the channel state report setting.

Aspect 3: The method of aspect 2, wherein a first subset of the set of code points are configured for reporting a layer one RSRP of a received beam and a second subset of the set of code points are remaining code points, wherein the remaining code points are invalid for reporting the layer one RSRP of the received beam, and wherein transmitting the code point comprises: transmitting the code point that is selected from the second subset of the set of code points.

Aspect 4: The method of any of aspects 2 through 3, further comprising: receiving, from the base station, a message indicating a request configuration, wherein the request configuration comprises an indication of the code point for indicating use of the additional reporting quantity for the channel state report setting or the one or more changed parameters of the channel state report setting.

Aspect 5: The method of any of aspects 2 through 4, wherein transmitting the request comprises: transmitting an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits.

Aspect 6: The method of any of aspects 2 through 5, wherein different respective code points in the set of code points of the beam report indicate use of different respective reporting quantities for the channel state report or different respective parameters for the channel state report.

Aspect 7: The method of any of aspects 2 through 6, wherein the beam report comprises a first report for reporting a strongest beam in terms of either a layer one RSRP or a layer one SINR, and wherein transmitting the request to the base station comprises: transmitting the request indicating to the base station to interpret a second report for reporting a second strongest beam in terms of either the layer one RSRP or the layer one SINR as reporting the strongest beam in terms of either the layer one RSRP or the layer one SINR.

Aspect 8: The method of aspect 7, wherein transmitting the channel state report comprises: transmitting the second report indicating at least one of an absolute RSRP or an absolute SINR of the strongest beam, wherein a first step size associated with reporting the absolute RSRP or the absolute SINR of the strongest beam in the second report is different than a second step size associated with reporting a differential RSRP or a differential SINR of the strongest beam in the first report.

Aspect 9: The method of any of aspects 7 through 8, further comprising: transmitting, with the channel state report, the second report, wherein the second report indicates, based at least in part on the request, to interpret a previous strongest beam indicated by a previous first beam report in a previous channel state report as the strongest beam.

Aspect 10: The method of any of aspects 7 through 9, further comprising: transmitting, with the channel state report, the second report, wherein the second report indicates, based at least in part on the request, to interpret the first report as reporting the strongest beam according to an updated reporting configuration.

Aspect 11: The method of any of aspects 2 through 10, wherein transmitting the channel state report based at least in part on the configuration and the request comprises: transmitting a second set of beam reports using a second number of bits based at least in part on the request, wherein the second number of bits is less than a first number of bits configured for transmitting a first set of beam reports according to the configuration, wherein the second set of beam reports comprises the beam report.

Aspect 12: The method of aspect 11, wherein the second set of beam reports comprises less beam reports than the first set of beam reports.

Aspect 13: The method of any of aspects 11 through 12, wherein each of the first set of beam reports and the second set of beam reports are associated with a respective range, and a second range of at least one beam report of the second set of beam reports is less than a first range of a corresponding beam report of the first set of beam reports.

Aspect 14: The method of any of aspects 11 through 13, wherein each of the first set of beam reports and the second set of beam reports are associated with a respective step size, and a second step size of at least one beam report of the second set of beam reports is less than a first step size of a corresponding beam report of the first set of beam reports.

Aspect 15: The method of any of aspects 1 through 14, wherein transmitting the request comprises: transmitting, with the channel state report, a bit in addition to a payload of the channel state report, the bit indicating the request.

Aspect 16: The method of aspect 15, wherein transmitting the channel state report comprises: indicating, via one or more bits associated with the payload of the channel state report, the additional reporting quantity for the channel state report or the one or more parameters of the channel state report.

Aspect 17: The method of any of aspects 15 through 16, wherein transmitting the channel state report comprises: indicating, via one or more bits in addition to the payload of the channel state report, the additional reporting quantity for the channel state report or the one or more parameters of the channel state report.

Aspect 18: The method of any of aspects 15 through 17, wherein transmitting the channel state report based at least in part on the configuration and the request comprises: transmitting a second set of beam reports using a second number of bits based at least in part on the request, wherein the second number of bits is less than a first number of bits configured for transmitting a first set of beam reports according to the configuration.

Aspect 19: The method of any of aspects 1 through 18, wherein transmitting the request comprises: transmitting an indication to change a periodicity associated with future channel state reports.

Aspect 20: The method of any of aspects 1 through 19, wherein the configuration for the channel state report setting comprises a set of scheduled channel state reports, and wherein transmitting the request comprises: transmitting a message requesting a second channel state report in addition to the set of scheduled channel state reports.

Aspect 21: The method of any of aspects 1 through 20, wherein transmitting the request comprises transmitting a message requesting to change the one or more parameters, and the one or more parameters comprise a number of CSI-RS resources associated with the channel state report setting or a number of SSB resources associated with the channel state report setting.

Aspect 22: The method of any of aspects 1 through 21, wherein transmitting the request comprises: transmitting a message reporting a predicted beam change incident.

Aspect 23: The method of any of aspects 1 through 22, wherein the additional reporting quantity comprises an SSB index RSRP, an SSB index SINR, a channel state information resource indicator RSRP, or a channel state information resource indicator SINR.

Aspect 24: A method for wireless communications at a base station, comprising: transmitting, to a UE, a configuration for a channel state report setting, wherein the configuration for the channel state report setting is associated with a number of bits; receiving, from the UE, a request for an additional reporting quantity for the channel state report setting or to change one or more parameters of the channel state report setting; and receiving, from the UE, a channel state report using the number of bits based at least in part on the configuration and the request.

Aspect 25: The method of aspect 24, wherein receiving the request comprises: receiving, with the channel state report, a code point of a set of code points of a beam report, indicating use of the additional reporting quantity for the channel state report setting or one or more changed parameters of the channel state report setting.

Aspect 26: The method of aspect 25, wherein a first subset of the set of code points are configured for reporting a layer one RSRP of a received beam and a second subset of the set of code points are remaining code points, wherein the remaining code points are invalid for reporting the layer one RSRP of the received beam, and wherein receiving the code point comprises: receiving the code point that is selected from the second subset of the set of code points.

Aspect 27: The method of any of aspects 25 through 26, further comprising: transmitting, to the UE, a message indicating a request configuration, wherein the request configuration comprises an indication of the code point for indicating use of the additional reporting quantity for the channel state report setting or the one or more changed parameters of the channel state report setting.

Aspect 28: The method of any of aspects 25 through 27, wherein receiving the request comprises: receiving an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits.

Aspect 29: An apparatus for wireless communications at a UE, comprising a processor; memory coupled with the processor; and instructions stored in the memory and executable by the processor to cause the apparatus to perform a method of any of aspects 1 through 23.

Aspect 30: An apparatus for wireless communications at a UE, comprising at least one means for performing a method of any of aspects 1 through 23.

Aspect 31: A non-transitory computer-readable medium storing code for wireless communications at a UE, the code comprising instructions executable by a processor to perform a method of any of aspects 1 through 23.

Aspect 32: An apparatus for wireless communications at a base station, comprising a processor; memory coupled with the processor; and instructions stored in the memory and executable by the processor to cause the apparatus to perform a method of any of aspects 24 through 28.

Aspect 33: An apparatus for wireless communications at a base station, comprising at least one means for performing a method of any of aspects 24 through 28.

Aspect 34: A non-transitory computer-readable medium storing code for wireless communications at a base station, the code comprising instructions executable by a processor to perform a method of any of aspects 24 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a configuration for a channel state report setting, wherein the configuration for the channel state report setting is associated with a number of bits;
transmitting, to the base station, a request for an additional reporting quantity for the channel state report setting or to change one or more parameters of the channel state report setting; and
transmitting, to the base station, a channel state report using the number of bits based at least in part on the configuration and the request.

2. The method of claim 1, wherein transmitting the channel state report comprises:
transmitting, with the channel state report, a code point of a set of code points of a beam report, the code point indicating use of the additional reporting quantity for the channel state report setting or one or more changed parameters of the channel state report setting.

3. The method of claim 2, wherein a first subset of the set of code points are configured for reporting a layer one reference signal received power of a received beam and a second subset of the set of code points are remaining code points, wherein the remaining code points are invalid for reporting the layer one reference signal received power of the received beam, and wherein transmitting the code point comprises:
transmitting the code point that is selected from the second subset of the set of code points.

4. The method of claim 2, further comprising:
receiving, from the base station, a message indicating a request configuration, wherein the request configuration comprises an indication of the code point for indicating use of the additional reporting quantity for the channel state report setting or the one or more changed parameters of the channel state report setting.

5. The method of claim 2, wherein transmitting the request comprises:
transmitting an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits.

6. The method of claim 2, wherein different respective code points in the set of code points of the beam report indicate use of different respective reporting quantities for the channel state report or different respective parameters for the channel state report.

7. The method of claim 2, wherein the beam report comprises a first report for reporting a strongest beam in terms of either a layer one reference signal received power or a layer one signal to interference and noise ratio, and wherein transmitting the request to the base station comprises:
transmitting the request indicating to the base station to interpret a second report for reporting a second strongest beam in terms of either the layer one reference signal received power or the layer one signal to interference and noise ratio as reporting the strongest beam in terms of either the layer one reference signal received power or the layer one signal to interference and noise ratio.

8. The method of claim 7, wherein transmitting the channel state report comprises:
transmitting the second report indicating at least one of an absolute reference signal received power or an absolute signal to interference and noise ratio of the strongest beam, wherein a first step size associated with reporting the absolute reference signal received power or the absolute signal to interference and noise ratio of the strongest beam in the second report is different than a second step size associated with reporting a differential reference signal received power or a differential signal to interference and noise ratio of the strongest beam in the first report.

9. The method of claim 7, further comprising:
transmitting, with the channel state report, the second report, wherein the second report indicates, based at least in part on the request, to interpret a previous strongest beam indicated by a previous first beam report in a previous channel state report as the strongest beam.

10. The method of claim 7, further comprising:
transmitting, with the channel state report, the second report, wherein the second report indicates, based at least in part on the request, to interpret the first report as reporting the strongest beam according to an updated reporting configuration.

11. The method of claim 2, wherein transmitting the channel state report based at least in part on the configuration and the request comprises:
transmitting a second set of beam reports using a second number of bits based at least in part on the request, wherein the second number of bits is less than a first number of bits configured for transmitting a first set of beam reports according to the configuration, wherein the second set of beam reports comprises the beam report.

12. The method of claim 11, wherein the second set of beam reports comprises less beam reports than the first set of beam reports.

13. The method of claim 11, wherein:
each of the first set of beam reports and the second set of beam reports are associated with a respective range, and
a second range of at least one beam report of the second set of beam reports is less than a first range of a corresponding beam report of the first set of beam reports.

14. The method of claim 11, wherein:
each of the first set of beam reports and the second set of beam reports are associated with a respective step size, and
a second step size of at least one beam report of the second set of beam reports is less than a first step size of a corresponding beam report of the first set of beam reports.

15. The method of claim 1, wherein transmitting the request comprises:
transmitting, with the channel state report, a bit in addition to a payload of the channel state report, the bit indicating the request.

16. The method of claim 15, wherein transmitting the channel state report comprises:
indicating, via one or more bits associated with the payload of the channel state report, the additional reporting quantity for the channel state report or the one or more parameters of the channel state report.

17. The method of claim 15, wherein transmitting the channel state report comprises:
indicating, via one or more bits in addition to the payload of the channel state report, the additional reporting quantity for the channel state report or the one or more parameters of the channel state report.

18. The method of claim 15, wherein transmitting the channel state report based at least in part on the configuration and the request comprises:
transmitting a second set of beam reports using a second number of bits based at least in part on the request, wherein the second number of bits is less than a first number of bits configured for transmitting a first set of beam reports according to the configuration.

19. The method of claim 1, wherein transmitting the request comprises:
transmitting an indication to change a periodicity associated with future channel state reports.

20. The method of claim 1, wherein the configuration for the channel state report setting comprises a set of scheduled channel state reports, and wherein transmitting the request comprises:
transmitting a message requesting a second channel state report in addition to the set of scheduled channel state reports.

21. The method of claim 1, wherein:
transmitting the request comprises transmitting a message requesting to change the one or more parameters, and
the one or more parameters comprise a number of channel state information reference signal resources associated with the channel state report setting or a number of synchronization signal block resources associated with the channel state report setting.

22. The method of claim 1, wherein transmitting the request comprises:
transmitting a message reporting a predicted beam change incident.

23. The method of claim 1, wherein the additional reporting quantity comprises a synchronization signal block index reference signal received power, a synchronization signal block index signal to interference and noise ratio, a channel state information resource indicator reference signal received power, or a channel state information resource indicator signal to interference and noise ratio.

24. A method for wireless communications at a base station, comprising:
transmitting, to a user equipment (UE), a configuration for a channel state report setting, wherein the configuration for the channel state report setting is associated with a number of bits;
receiving, from the UE, a request for an additional reporting quantity for the channel state report setting or to change one or more parameters of the channel state report setting; and
receiving, from the UE, a channel state report using the number of bits based at least in part on the configuration and the request.

25. The method of claim 24, wherein receiving the request comprises:
receiving, with the channel state report, a code point of a set of code points of a beam report, indicating use of the additional reporting quantity for the channel state report setting or one or more changed parameters of the channel state report setting.

26. The method of claim 25, wherein a first subset of the set of code points are configured for reporting a layer one reference signal received power of a received beam and a second subset of the set of code points are remaining code points, wherein the remaining code points are invalid for reporting the layer one reference signal received power of the received beam, and wherein receiving the code point comprises:
receiving the code point that is selected from the second subset of the set of code points.

27. The method of claim 25, further comprising:
transmitting, to the UE, a message indicating a request configuration, wherein the request configuration comprises an indication of the code point for indicating use of the additional reporting quantity for the channel state report setting or the one or more changed parameters of the channel state report setting.

28. The method of claim 25, wherein receiving the request comprises:
receiving an indication of the additional reporting quantity for the channel state report setting or the one or more changed parameters of the channel state report setting using either a first set of bits for reporting the set of code points or a second set of bits of a payload of the channel state report, where the second set of bits is different from the first set of bits.

29. An apparatus for wireless communications at a user equipment (UE), comprising:
a processor;
memory coupled with the processor; and
instructions stored in the memory and executable by the processor to cause the apparatus to:
receive, from a base station, a configuration for a channel state report setting, wherein the configuration for the channel state report setting is associated with a number of bits;
transmit, to the base station, a request for an additional reporting quantity for the channel state report setting or to change one or more parameters of the channel state report setting; and
transmit, to the base station, a channel state report using the number of bits based at least in part on the configuration and the request.

30. An apparatus for wireless communications at a base station, comprising:
a processor;
memory coupled with the processor; and
instructions stored in the memory and executable by the processor to cause the apparatus to:
transmit, to a user equipment (UE), a configuration for a channel state report setting, wherein the configuration for the channel state report setting is associated with a number of bits;
receive, from the UE, a request for an additional reporting quantity for the channel state report setting or to change one or more parameters of the channel state report setting; and
receive, from the UE, a channel state report using the number of bits based at least in part on the configuration and the request.
